(19) United States
(12) Patent Application Publication
(10) Pub. No.: US 2022/0203617 A1
(43) Pub. Date: Jun. 30, 2022

(54) AUTOMATED PART REMOVAL FOR ADDITIVE MANUFACTURING

(71) Applicant: PEKTECH HOLDINGS INC., Vancouver (CA)

(72) Inventor: Mateo Petar PEKIC, Vancouver | (CA)

(21) Appl. No.: 17/601,411

(22) PCT Filed: Apr. 3, 2020
(86) PCT No.: PCT/CA2020/050450

§ 371 Date: Oct. 4, 2021

Related U.S. Application Data
(60) Provisional application No. 62/829,532, filed on Apr. 4, 2019.

(51) Int. Cl. B29C 64/245; B29C 35/16; B29C 64/295; B29C 64/40

(52) U.S. Cl. CPC B29C 64/245; B29C 35/16; B33Y 40/20; B29C 64/40; B29C 2035/1608; B29C 64/295

(57) ABSTRACT

Apparatus for facilitating automated removal of a printed part from a 3D printer's print bed includes a print surface applied to the print bed, wherein the print surface has properties which change with temperature, affecting adhesion to the printed part. Cycling the temperature of the print bed enables adhesion of the part to the print bed during printing and release of the part from the print bed upon completion of the print. The print bed may be oriented vertically or at an incline to the horizontal to enable gravitational forces to pull the printed part away from the print bed upon completion of the print. Peltier devices or other cooling mechanisms may be provided to facilitate cooling of the print bed for release of the part. In certain embodiments, the print bed is configured to provide mechanical part removal to automatically dislodge the printed part from the print bed.

### RELATED APPLICATION

This application claims priority from United States Provisional Patent Application No. 62/829,532 filed Apr. 4, 2019 entitled AUTOMATIC PART REMOVAL FOR ADDITIVE MANUFACTURING. For the purposes of the United States, this application claims the benefit under 35 USC § 119 of U.S. Provisional Patent Application No. 62/829,532 filed Apr. 4, 2019 entitled AUTOMATIC PART REMOVAL FOR ADDITIVE MANUFACTURING which is incorporated herein by reference in its entirety.

### TECHNICAL FIELD

This present disclosure relates generally to systems and methods for additive manufacturing, including systems and methods for automated removal of parts and coordination of 3D printing among a plurality of printers.

### BACKGROUND

The use of three-dimensional (3D) printing machines (also referred to herein as “3D printers”) to produce physical 3D objects provides many advantages over traditional manufacturing techniques. For example, 3D printing can: be inexpensive for producing low-volume parts, enable the manufacturing of objects with certain geometries which are difficult or impossible to accomplish through other means such as injection molding, eliminate the need for specialized tooling for each manufactured object, and be used to output a variety of products from the same machine. As a result, 3D printing can be a more economical and environmentally-sustainable process than other forms of manufacturing. Well-built 3D printing machines can also print with high accuracy, producing objects within tolerances of +/−0.05 mm.

One type of 3D printing uses fused filament fabrication (FFF) techniques. An example 3D printer 10 that can be used for FFF 3D printing is illustrated in FIG. 1. FFF 3D printing creates objects by heating a filament of printing material and depositing it onto a print bed 105 (also referred to as a printing platform) supported on a print frame 106. The print bed 105 is typically coated in a media, which serves as the print surface. Printing material is extruded through a nozzle of the hot end assembly 104 and deposited in successive layers to form the completed 3D object 150, also referred to as a print, part, printed part or deposited model. The printing material that is used for FFF 3D printing may be a thermoplastic or thermoplastic elastomer, for example.

The 3D printer 10 that is illustrated in FIG. 1 is a Mendel-style printer. Such a printer has a print bed 105 that is oriented horizontally (i.e. parallel to the ground) and is controlled to move along a horizontal y-axis. The hot end assembly 104 incorporating the nozzle is controlled to move in directions along a horizontal x-axis and a vertical z-axis. By moving the print bed 105 along the y-axis and the hot end assembly 104 along the x- and z-axes, a 3D printed part 150 can be formed through extrusion of the printing material from the nozzle, depositing layer upon layer on the print bed 105 to build the printed part 150.

Alignment among the sequence layers throughout the print job affects the quality of the part. 3D printing material can expand or contract upon deposition, which can cause misalignment in layers, shifting, warping or delamination from the print bed. To avoid malformed, defective or failed prints, strong adhesion between the initial layer of printing material and the print surface is required. Adhesion depends on many factors, including the characteristics of the printing material, geometry of the part, weight distribution, shape and location of the footprint, temperature of the print surface, and speed at which the initial layer is printed. The level of adhesion between the initial layer of printing material and the print surface largely determines the success of the print job.

On the other hand, if the part adheres too strongly to the print surface, it can be difficult for the operator (generally, a 3D printing technician) to remove the part from the print surface. Removal is typically accomplished by an operator scraping, pulling, pushing or otherwise manually moving the part off the print surface.

Thus, providing an adequate print surface involves tradeoffs between initial layer adhesion and ease of removal of the completed part from the print surface. To ensure the quality of the part and increase the success of prints, 3D printing operations tend to operate on the side of having too much adhesion to the print surface. However, excessive adhesion can result in damage to the printed part and the print surface, and occasionally injury to the technician. Excessive adhesion can also result in deposited printing material becoming permanently bonded to the print surface, or damaged parts of the print surface becoming permanently embedded in the printed part.

In addition to difficulties associated with removal of the part from the print bed, there are other inefficiencies with 3D printing. For example, after each print job, the technician needs to manually reset the print surface. This can be a slow and labour-intensive process. As the parts are often too strongly adhered to the print bed and removal of the part can cause damage to the print surface, consumable print surfaces are often used, so that they can be replaced as needed to maintain the overall success rate of print jobs. Replacement of print surfaces is another manual task that needs to be handled by a 3D printing technician. 3D printers also need to be sufficiently spaced apart so that a technician can access and perform all of the tasks comfortably. This requirement prevents 3D printers from being arranged in a dense or efficient configuration.

The immoderate amount of labour and intervention that is required to run a 3D printer restricts both its maximum size and output. These and other problems have generally hindered the scaling of 3D printing for mass manufacturing. While some larger FFF 3D print farms exist, they tend to cap at approximately 300 printers and operate on slim margins.

Attempts have been made to address the problem of removal of a 3D printed part from its print bed. One solution for removal of a part from the print bed involves a rolling bed. The print surface is provided as a continuous conveyor belt made of common print surface materials, such as a tape made from polyimide film with silicone adhesive. Parts become detached by rolling them off the end of the conveyor belt. The curved surface of the roller pulls the belt away from the printed part, allowing the part to peel off from the belt. As force is still involved in the removal of prints, the belt tends to wear out over time. Due to its length, replacing a belt is equivalent to disposing of enough material to cover three to five regular print surfaces. It does not wear evenly from printing, so it can develop dead spots which are difficult or impossible to track, often resulting in a belt with plenty of good material being thrown out. The belt material limits what types of plastic can be deposited on it, and different types of belts may need to be used for certain printing materials. The belt is also difficult to keep at a consistent height, which is important for adhesion of the initial layer to the print surface. The belt also requires additional moving parts which introduce potential jam points. If any material gets under the belt or the rollers, its surface will change and affect all subsequent prints. Prints with small footprints might not detach from the roller and can jam underneath or loop back around. Prints with large footprints that adhere too well can damage the surface of the belt as they go over the edge. Printers whose beds are used as the x- or y-axis print slower in general, and the added weight of the belt only exaggerates that limitation.

Another solution for removal of a part from the print bed involves removable beds. In particular, some 3D printers are capable of ejecting the entire print bed upon completion of a print and inserting a new print bed automatically. This introduces a number of moving parts and jam points. Further, this solution does not truly automate the removal process, given that it simply defers part removal so that the printed parts can be removed in batches from the print bed by a technician. While removable print beds do allow for 3D printers to run longer, manual labour is still required to remove the printed parts. Print bed surfaces also need to be reset manually by a technician (such as by replacing the tape coating) and then loaded back into the printer. In addition, if a print fails, it consumes an entire print cycle and wastes one print slot since there are only a finite amount of print beds. Every print bed that is wasted due to a failed print lowers the overall potential run time of the system. When a print fails, a technician needs to reset, redress and replace the removable print bed, so failed prints and wasted print beds typically mean that technicians must do more work in a shorter time frame. In addition, a separate storage area and a means of transferral are required for printed parts and print beds. While this can be acceptable for smaller print operations, the low density of this system is an obstacle to scaling up the operations.

Another solution for removal of a part from the print bed involves the use of robotic arms to replace a technician's arm for part removal. Robotic arms have difficulty in adapting to different situations, which is problematic for 3D printing since one of the objectives of a 3D print farm is to efficiently create a large variety of objects using the same equipment. If a robotic arm is used to remove parts, it would need highly advanced machine vision and an understanding of how to grip each printed part (with a system that links the robotic arm to the part), or a technician to manually train it. Robotic armature solutions also suffer from large space requirements. Given that gripping individual printed parts with robotic arms is not generally feasible, their use is largely limited to removal of entire build platforms, such as removable bed solutions, as described above.

Other solutions for removal of a part from the print bed involve a scraper. Some 3D printers have implemented an automated scraper, which replicates how a human would use a spatula to peel parts off the print bed. It introduces a complicated array of moving parts that tend to jam when these parts move unexpectedly. Once a printed part is scraped off, it is pushed into a collection tray. As the scraping is a forceful process, the print surface can suffer wear and a loss in performance. The scraper can also damage the printed part in some cases. The scraping process is not compatible with every material and current methods that use scraping do not account for the different material properties. It can also require a specialised print surface that is not compatible with all printing materials.

Other solutions for removal of a part from the print bed involve the use of a ceramic pattern deposited on glass that changes geometry based on its temperature. The behaviour of such a print bed varies greatly with the shape and composition of the part and the print surface, and may be inconsistent and unpredictable. Sometimes it fully releases parts, and other times it simply reduces adhesion. The release action is mechanical. In particular, upon cooling of the print bed, the print bed and the printed part experience different rates of thermal contraction and this results in mechanical displacement of the adhesion points relative to their original contact points with the printed part, as the adhesion between the print surface and printed part is broken through the thermal contraction. Since mechanical action is required, the adhesion points on the bed erode over time, causing the print surface to wear out after only a few weeks of optimal performance. The print surface needs to be redressed or replaced after a number of prints.

In general, where there is a bank of 3D printers being used by multiple parties, a team of people is needed to manage and coordinate the use of the 3D printers. Existing print control and queuing programs generally enable control over single printers, but do not coordinate the use of multiple printers or automate print job delegation for a group of 3D printers. In addition, these programs may not be adapted to handle issues specific to 3D printing, such as 3D print quality control and the removal and collection of printed parts. These challenges result in inefficiencies in the use of such programs for manufacturing products through 3D printing.

As such, there is a need for systems and methods which make 3D printing more efficient at higher volumes of printing. Systems and methods are needed in particular to reduce manual efforts and intervention in 3D printing, including by automating the steps in 3D printing, such as the removal of a printed part from a print bed. Systems and methods are needed to address or ameliorate one or more of the aforementioned disadvantages of existing solutions for removal of a printed part. Systems and methods are also needed to manage and coordinate the use of 3D printers to reduce inefficiencies in the manufacturing of products.

### SUMMARY OF THE DISCLOSURE

The present specification relates to apparatus, systems and methods for automating a fused filament fabrication (FFF) 3D printing process. Embodiments described herein incorporate mechanisms and processes for automatic part removal.

One aspect provides a print surface applied to a print bed to facilitate release of a part printed by a 3D printer from the print bed. The print surface comprises a material which bonds to the deposited printing material when heated, and once cooled, loses its bond to the deposited printing material due at least in part to a change in surface energy. The material bonds to the deposited printing material when the print surface is heated to an operating temperature within a certain range of the glass transition temperature of the deposited printing material. In certain embodiments, the operating temperature is in the range of −20° C. and 275° C. The material used for the print surface may be a glass-reinforced epoxy laminate material.

In particular embodiments, the print bed is oriented vertically, substantially vertically, or at an incline to the horizontal, and as the print surface is cooled from the operating temperature the surface energy decreases sufficiently such that gravity supplies at least 80% of the energy needed to overcome the mechanisms adhering the part to the print bed. In some embodiments, this occurs when the drop in temperature of the print surface is in the range of 5° C. to 20° C. from the operating temperature.

Another aspect provides a method of facilitating automated removal of a printed part from a print bed of a 3D printer. The method includes applying to the print bed a print surface as described herein, and cycling the temperature of the print surface to change the properties of the print surface to enable adhesion of the part to the print bed during printing and release of the part from the print bed upon completion of the print. The method may include orienting the print bed vertically or substantially vertically to enable gravity to pull the printed part away from the print bed upon completion of the print, or orienting the print bed at an incline to the horizontal to enable gravity to pull the printed part off the print bed upon completion of the print. In some embodiments, Peltier devices are provided under the print bed to facilitate cooling of the print bed for release of the part from the printed bed.

The method may include conducting a sweep of the print bed upon completion of the print to dislodge the printed part; vibrating the print bed upon completion of the print to dislodge the printed part; and/or using one or more of an ion gun, air blade, air compressor, and anti-static compound applied to the print surface to assist with dislodging the printed part upon completion of the print.

Another aspect provides apparatus for facilitating automated removal of a printed part from a 3D printer. The apparatus includes a print surface as described herein applied to a print bed of the 3D printer and one or more heating and/or cooling mechanisms to cycle the temperature of the print surface to change the properties of the print surface to enable adhesion of the part to the print bed during printing and release of the part from the print bed upon completion of the print. The apparatus may incorporate a support for orienting the print bed vertically or substantially vertically to enable gravity to pull the printed part away from the print bed upon completion of the print, or a support for orienting the print bed at an incline to the horizontal to enable gravity to pull the printed part off the print bed upon completion of the print. In some embodiments, the apparatus includes a Peltier device installed under the print bed to facilitate cooling of the print bed for release of the part from the printed bed.

Particular embodiments of the apparatus include a sweeper operable to move across the print bed upon completion of the print to dislodge the printed part, a vibration mechanism for vibrating the print bed upon completion of the print to dislodge the printed part, and/or one or more of an ion gun, air blade, air compressor, and anti-static compound applied to the print surface to assist with automatically dislodging the printed part upon completion of the print and after adhesion is released.

In some embodiments, a filament detection mechanism is included to track the use of printing material filament. The filament detection mechanism may comprise a load cell incorporated with the filament mount.

Other aspects are directed to a system for control and management of print jobs to one or more 3D printers incorporating the apparatus described above. The system may perform one or more of the following functions: remote printer control, print job delegation, print job scheduling, print failure detection, quality checks, inventory management, automatic filament setting generation, and print packing. Data concerning printer status is aggregated from the network of 3D printers and is used to inform the functions executed by the system.

Additional aspects of the invention will be apparent in view of the description which follows.

### BRIEF DESCRIPTION OF THE DRAWINGS

Features and advantages of the embodiments of the present invention will become apparent from the following detailed description, taken in with reference to the appended drawings in which:

FIG. 1 illustrates a Mendel-style 3D printer;

FIG. 2 illustrates a 3D printing apparatus according to one embodiment;

FIG. 3 is an exploded view of a print bed assembly of the 3D printing apparatus of FIG. 2;

FIGS. 4A, 4B and 4C (collectively, FIG. 4) illustrate various views of a hot end assembly of the 3D printing apparatus of FIG. 2;

FIG. 5A is a cross-section view of a part printed in horizontal printing orientation and FIG. 5B shows a cross-section view of a similar part printed in vertical printing orientation;

FIGS. 6A and 6B (collectively, FIG. 6) show a hot end assembly of a 3D print assembly; and

FIG. 7 is a schematic illustration of a local system for a print farm according to one embodiment.

FIGS. 8A to 8C (collectively, FIG. 8) depict various bounding meshes for print packing;

FIGS. 9A and 9B (collectively, FIG. 9) depict packing printed models within a print packing volume;

FIG. 10 is a schematic illustration of a cloud-based system for a print farm according to one embodiment;

FIG. 11 is a flowchart of a method of automatic profile settings generation according to one embodiment;

FIGS. 12A and 12B (collectively, FIG. 12) is a flowchart of a process for automated print process monitoring and live settings changes according to one embodiment;

FIG. 13 is a flowchart of a process for automatic print failure detection according to one embodiment; and

FIGS. 14A to 14D (collectively, FIG. 14) are cross-sectional views of a print bed assembly with perforations disposed throughout the print surface for air or gas flow according to one embodiment.

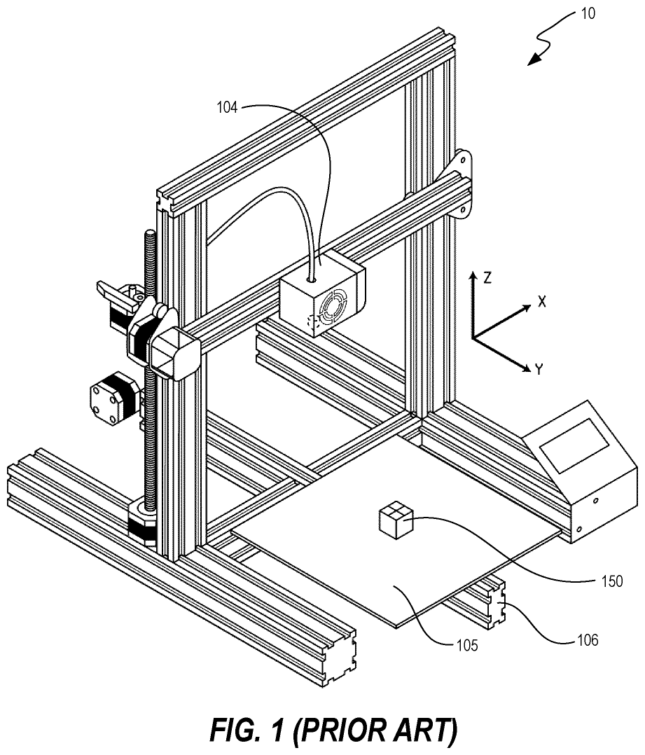

### DETAILED DESCRIPTION

The description which follows, and the embodiments described therein, are provided by way of illustration of examples of particular embodiments of the principles of the present invention. These examples are provided for the purposes of explanation, and not limitation, of those principles and of the invention.

The process of producing a part using 3D printing is customarily comprised of many steps with intensely manual transitions. The process can be broken down into 3D model design, slicing, printer setup, scheduling, printing, print process monitoring, part removal, quality control, and material sorting/handling. Every handover between the steps of the process normally requires intervention by a human operator. These steps also tend to use distinct pieces of software and equipment, and the operator's judgement is frequently called upon to facilitate the handover.

Each step is often generalized to handle any geometry of a given 3D printed part, and circumstances may occur where a part supported by one step of the workflow is not supported by the others. An operator's experience and judgement may be required to modify the parameters of the part, print settings, or any other configurable property to move along the printing process. For example, at the 3D model design stage, one can design a part floating in mid air. However, a printer cannot physically print a part that is floating unsupported in mid-air. Therefore, the operator may be required to exercise their skill and judgement to add suitable supports to the part in the slicing step.

In some operations, certain steps can be entirely reliant on the operator as it may be simply more convenient to rely on their judgement than having to translate the part and workflow into yet another discrete piece of software. The largest of these manual operator-dependant tasks are scheduling, print process monitoring, part removal, and quality control, each of which is briefly discussed below.

In respect of scheduling, there is a three-way interplay between scheduling, part removal, and quality control, as described herein. When a printer completes printing a part, it must wait for an operator to remove the part from the print surface. New parts cannot be printed until the existing parts are removed. An operator cannot remove the completed parts if they are busy. The operator's workload at any given moment depends on how many other printers are waiting for part removal, whether prints have failed or do not meet quality standards and need to be reprinted (and scheduled among the other prints), printer maintenance, etc. As such, the operator's response time for any given event (including part removal) can be inconsistent because it depends on an interaction of variables whose complexity scales with the number of printers deployed in a print farm.

Due to this inconsistent response timing, it becomes difficult to accurately schedule print farms relatively far in advance, with most existing solutions relying on factoring in significant buffer time. Certain events can line up to occupy much of the operator's time and can cause extended periods of downtime. For example, if ten printers are finishing a print job at once, the tenth printer has to wait for all nine other printers to be cleared and reset before the operator can tend to it. At any other time, it may have been the only printer requiring reset, so the response time would have been ten times faster. In general, the closer a print farm runs to maximum capacity, the more operator time would have to be restricted, eventually requiring one operator per printer, which is cost prohibitive.

A description of manual intervention with respect to print process monitoring is presented. Because any shape can be printed on a 3D printer, it is often difficult to build a generalized method for determining the optimal performance during a print. Operators are often given part specifications that they have to meet, but identifying issues during printing is important to prevent downtime. Since parts take time to print, it may make sense to cancel a print job if the partially printed part is deemed defective. Allowing the printer to continue printing during a failure results in wasted time, material, and possible damage. Process monitoring in conventional 3D printing systems is often subjective, as there are many criteria that determine the success of a print, and thresholds vary by the operator's judgement. Accordingly, inter-operatory variations may exist across a collection of printed parts and even among printers.

Once a part has been printed and the operator determines that part specifications are met, the operator must spend time removing the printed part(s) from the print surface.

Different parts can present different removal challenges, as described more fully below.

Because part removal is manually conducted, operators may further perform quality control (QC) on every part produced. For the same reasons above, this manual inspection is not scalable to a large number of parts, and can also be subjective leading to inconsistencies in QC.

In addition to the foregoing, significant human/operator input may also be required for slicing and material sorting/handling. Furthermore, significant human/operator input may be required for other pre-process and post process steps in the 3D printing workflow, which include slicing and part sorting.

With respect to slicing, this step is often one of the most complicated and variable. Operators must import any conceivable model into the slicing software and determine from various settings which values are optimal for the print job having regard to:
Part Intention: how the part is used and taking into consideration of the trade-offs between strength, tolerance, and quality.
Material: different print materials behave differently when molten and can require different speed and temperature settings for printing the same geometry.
Environmental Factors: humidity, dust or other airborne particulate, and ambient temperature can affect how the extruded print material behaves, and this behaviour change needs to be compensated to achieve consistent print results. The operator may also need to consider temperature fluctuations throughout the course of a print job as well as heat exhaust and vibrations from nearby equipment.
Printer Hardware: it is generally understood that a printer can only print parts and use materials supported by or compatible with its hardware. For example, if an object is larger than the printer's print area, it may have to be oriented in a different manner to allow the part to fit. Certain hardware may not be able to reach the temperatures required for a given print material to be extruded quickly, so speed settings may need to be adjusted by the operator to compensate.
Part Features: certain features may need to be supported with additional sacrificial structures. Parts for which printing is desired may also contain features that can only be printed in a specific orientation.

With respect to material sorting/handling, after the printed parts are removed, they are generally stored one-by-one in an inventory. As the removal is manual and parts only come off a machine every few hours, this material handling and sorting is often entirely manual. More complex automated systems would be cost prohibitive for low volumes.

The present invention provides apparatus, systems and methods for automating a fused filament fabrication (FFF) 3D printing process. Embodiments described herein incorporate mechanisms and processes for automatic part removal. Certain embodiments provide a system for managing and controlling the automated part removal and for coordination of printing among a network of 3D printers outfitted with the part removal mechanism. The printers may be a densely packed bank of FFF 3D printers. Each printer may be designed so as to be compatible with an existing assembly line or manufacturing process without requiring the addition of specialised machinery to ingest parts coming off the printer. The 3D printers may be mounted over existing conveyor belts, drop into a support dissolution tank, or feed directly into wherever parts are placed at the beginning of a further manufacturing process. Information from this system can also be passed onto further post processing and material handling processes.

The automated print removal process according to certain embodiments employs a print surface material which exhibits variable adhesion so as to secure objects during printing and then automatically release the objects when the print is completed. The print surface material can be fixed to an existing print platform. A self-releasing mechanism is provided through changing the temperature of the print bed to control the magnitude of adhesion to the print surface material. In particular, when the temperature drops below a threshold, the part no longer adheres to the print surface material and can be readily removed from the print bed with no (or minimal) damage to the part or the print surface. The print surface maintains optimal performance over extended periods as compared to print surfaces made of other materials which can degrade due to damage from the force of removal or wear out due to repeated use.

Certain embodiments provide printing apparatus that leverage the self-releasing properties of the print surface with temperature cycles and enable automatic removal of a printed part from the print surface upon completion of the print. In particular embodiments, the solution is to tilt the print bed so that it is oriented vertically (i.e. perpendicular to the ground, defining the horizontal plane), or at an incline with respect to the horizontal plane. Upon completion of a print job, the print surface material will have decreasing adhesion to the printed part with cooling of the print bed, until the force of gravity is sufficient to remove the part from the tilted print bed.

When a printed part is ready to be ejected, the print bed (still at above threshold temperature) moves to one end where the part will be able to clear the chassis when released due to the temperature cycling of the print bed. Prints may be dropped onto a shelf, or into a tray, bin, chute, liquid containing tank, or hammock positioned underneath the machines or moved away by a conveyor for collection elsewhere.

In general, print quality in the embodiments described herein is significantly affected by registration from one layer to the next and adequate support. If these factors are maintained, the angle at which the machine is oriented will have no noticeable impact on print success. As such, print quality is largely indiscriminate of the orientation of the print bed. The automated removal process described herein enables 3D printers to automatically begin executing another job as soon as the first one is complete, without requiring any manual reset of the print bed. In contrast, current 3D printing machines require a technician to manually reset the bed and mark the printer as available after each print job.

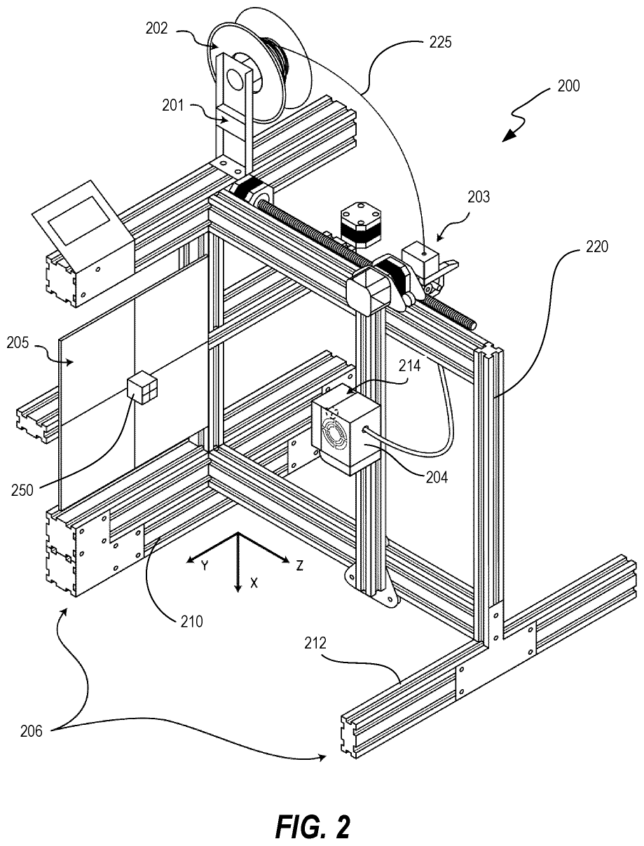

In certain embodiments, such as the FIG. 2 embodiment which is described below, the 3D printer has its print bed oriented vertically (perpendicularly to the ground) for optimal leverage of gravity. A vertical print surface reduces the risk of released prints colliding with moving parts or the hot nozzle of the printer.

In some embodiments, the prints are released from the print surface without the use of moving parts. In other embodiments, a mechanical sweeper is used to ensure removal of prints. A detection system may be provided to ensure that the print bed is clear before the next print begins.

By implementing automated part release, the task of part removal is excluded from the printing process, which permits a more consistent reset cycle that is independent of human operators. When part release is automated, printer cycle time becomes more predictable and scheduling can be automated. A larger number of printers can be commanded through a single point of contact. This allows for the operation of 3D print farms with greater scalability and lower operating cost, where schedules can be set relatively farther in advance.

However, eliminating the manual printer reset routine may result in QC not being conducted in real-time by the operator on a part-by-part basis. This “breakdown” highlights the relevance of a printer operator's judgement within a 3D printing workflow. The requirement of human examination also means that the workflow incorporates subjective procedures. Consequently, under existing printing systems, if two operators were given the same part design, two identical printers, and the same printing material, the parts produced may still be different because each operator would have used their own biases based on different experiences and processed the part through the printing workflow in a different way.

Because of this reliance on human judgement, consistency may only extend within the reach of a single operator. More operators would be needed to accommodate higher printing volumes. However, this may result in inconsistencies in the printed parts, and higher operational costs. As such, the use of human operators cannot be scaled reliably.

Fortunately, to achieve printing consistency from a QC perspective, a perfect solution is not always necessary. If a common baseline to model of an operator's judgement were to be deployed to all the printers, consistency borne from personal biases and a single human's inability to tend to all the printers can be eliminated.

Judgement from experience can be modeled for outcome prediction using current observed printing data, derived from a wealth of correlation between previous data (e.g. printing parameters) and known outcomes (e.g. whether the printed part that meets the desired specification). This type of correlation can be used in algorithmic modelling with machine learning. This approach generally requires two things: relatively objective but consistent methods of measurement, and a collection of data, as described more fully subsequently.

Automated print process management and QC can be realized in conjunction with automatic part release. As described more fully below, a system for networking the 3D printers and delivering live updates through a central interface can be deployed to allow operators to respond more quickly to potential faults, as well as to give them the ability to command a larger fleet of printers. This may initially begin with standard visual monitoring and remote printer access, which allows the operator to apply their judgement more widely effectively. Visual monitoring can include, but is not limited to, video monitoring, photographic monitoring, and timelapse photographic monitoring. However, the issue of print inconsistency between operators still remains. To address the foregoing, an automated warning and response system can further be deployed to facilitate scaling along with data collection using sensors placed at various locations on the printer.

The increase in scalability, increase in productivity, and lower cost afforded by part release automation makes it feasible for enough data to be generated and automatically collected to reasonably model the operator's judgement from experience. As described more fully below, the data may be used to build a central model of understanding (CMU) to help automate tasks within the printing workflow such as print process monitoring and QC. The automation can be implemented using software that sits between the user-generated inputs (e.g., print settings, part shape, etc.), and the observed outputs by an automated QC system.

In some embodiments, a print failure detection system is provided to facilitate print process management and quality control. The print failure detection system is configured to detect failures and abort prints upon detection of a failure. For example, a print which has a visible spaghetti-like nature may be recognized as a failure, because allowing prints like this to continue can pose a risk of catastrophic failure to the 3D printing machine. The print failure detection system may use a printer camera which images the part being printed on the print bed. (In some embodiments, this camera may also serve to provide video footage for a user interfacing remotely with the printer, as described below.) Using images from the printer camera, the print failure detection system provides one or more mechanisms to determine whether a print has failed. One mechanism may be based on image recognition software installed in the print failure detection system. The image recognition is based on training a neural network model to recognize features of failed prints from images obtained from the printer camera. Another mechanism may be based on comparing the actual output to a rendering of the printer instructions in 3D space—or the 3D model if supplied—from the same angle as the printer sensor's view of the bed, and detecting any differences.

Upon detection of a failure, the print failure detection system causes the 3D printing machine to perform one of the following actions: pause the print and wait for a technician to resume, abort or restart the print; automatically abort the print and suspend the printer from further operation until it is reinstated by an operator; automatically abort the print and restart the same print or start another print when the print bed is detected to be clear.

The print failure detection system or a similar such system is configured in certain embodiments to ensure that no plastic remains on the bed when the print surface is reset. The system has a camera to image the print bed, so that the system can use image recognition to detect anomalies from a comparison of the present bed to a baseline example. Where an anomaly is detected, indicating that plastic remains on the bed, the general location of the anomaly is determined by the system. The printer will attempt to dislodge the plastic remnants using an effector assembly at that location. The effector assembly may be configured to engage and move the cooled nozzle or a separate attachment to dislodge the plastic remnants.

Throughout this specification, numerous terms and expressions are used in accordance with their ordinary meanings. Provided immediately below are definitions of some terms and expressions that are used in the description that follows. Definitions of some additional terms and expressions that are used are provided elsewhere in the description.

A “part” refers to a singular 3D item printed by a 3D printer, and is also referred to as an object, print, printed part or deposited model.

A “model” is defined by the 3D print files submitted by the user. A model can consist of multiple separate parts.

A “queue item” refers to any individual listing in a print queue. The queue item can be a single model or assembly. The queue item may also contain information about how the item is to be processed and distributed. Multiple queue items can be combined in a single job.

A “job” refers to single or multiple models processed for printing. When sent to the printer, a job is sent as a single file of printer instructions, meaning that any parts contained within are printed in the same reset cycle.

In the context of a single printer, a “batch” refers to a job file (containing a set of print instructions) that is repeated. The repeated prints are identical in terms of contents and placement of the parts on the print surface. However, for the central print control and management service that is described herein, a batch incorporating identical jobs may be distributed among multiple printers. Each printer then runs a local batch (e.g. a batch of 6 identical jobs is distributed among a network of 3 printers, so that each printer runs a local batch of 2 jobs).

A “run” refers to models that are printed multiple times. Runs are created by submitting a model and setting the quantity modifier. Models from a five-thousand part run can result in multiple jobs, mixed with other models from other runs. Runs are comprised of all instances of a single model submitted to the queue. For example, two orders may be placed: one for 500 part A, and one for 300 part A and 200 part B. This results in two runs, one of 800 parts A, and 200 parts B.

A “lot” consists of multiple models manually grouped by the user to be printed together. e.g. a user needs 3 prints of part A, 2 prints of part B, and 3 prints of part C, to be printed together in one go. Lots can be assigned a quantity modifier. Lots comprise groups of runs, with a specific collection of parts being printed together in a certain quantity in a given print cycle. Their position on the bed can be automatically generated.

An “assembly” is similar to a lot in that an assembly is a group of multiple models. However, an assembly preserves the relative positions of these models as initially set by the user. An assembly can be used to set interlocking parts or arrange the models in a particular way. Once an assembly has been created, it is treated like a single model. However, even though it is a single model, each assembly counts toward the completion of the runs their constituent parts belong to.

A “multi-job order” (MJO), or more simply, an “order”, is a grouping of specific jobs in the queue. Orders can comprise runs. Orders can be used to track specific production of parts or mirror client orders. Orders are typically made up of one or more models, with a specified quantity and due date. In embodiments of the invention described herein, orders can be placed that do not have a specified quantity or due date (e.g. an order is specified in terms of parts/timeframe, with a certain rate and timeframe, or with a rate of production and a maximum number of parts). The timeframes of rates can be given over larger time scales (days, weeks, months) given the challenges in keeping the exact rate minute-by-minute when multiple runs are feeding into the queue.

A “print cycle” includes the execution of a print job and reset procedure. A print cycle begins and ends with no parts on the build plate.

Referring to FIG. 2, the 3D printer hardware is described in more detail below. FIG. 2 shows a 3D printing apparatus 200 according to one embodiment incorporating a 3D FFF printing machine or printer 220 outfitted with printer hardware to adapt the printer 220 for automated part removal. In the illustrated embodiment, the printer 220 is a Mendel-style printer having a frame 206 supporting a movable print bed assembly 205 and hot end assembly 204. One model that may be used for printer 220 is the Mendel-style Creality Ender-3 3D FFF printer. This model is constructed through 20-20 T-slot aluminum extrusion, which can be modified to adapt the printer for an automated part removal process in accordance with the embodiments described herein. It is not necessary that the printer 220 be a Mendel-style printer. Any 3D FFF printing machine which has a print bed and a hot end assembly may be outfitted with the particular features described herein to provide a printing apparatus 200 that enables automated part removal.

The printer 220 has a mount 201 for supporting a roll, spool or cartridge 202 of the printing material 225 which is fed into the hot end assembly 204. In the illustrated embodiment of FIG. 2, the printing material 225 is a filament on a spool 202. Hot end assembly 204 of printer 220 is operable to heat the filament of printing material 225 and deposit the material in layers onto the print bed assembly 205.

In the FIG. 2 printing apparatus 200, the Mendel-style printer 220 has been flipped onto its side so that the x-axis is vertical (perpendicular to the ground), and the y- and z-axes are horizontal (parallel to the ground). As a result, the print bed assembly 205 is rotated 90 degrees from its standard horizontal orientation, so that the print bed assembly 205 is oriented perpendicular to the ground. As the printing material is being extruded from the nozzle of hot end assembly 204, print bed assembly 205 is controllable to move along the horizontal y-axis while the hot end assembly 204 is controllable to move along the vertical x-axis and horizontal z-axis. The layers of printing material therefore build up perpendicularly from the print bed assembly 205 in the direction of the horizontal z-axis, to form a deposited model 250.

In the FIG. 2 embodiment, printing apparatus 200 incorporates a modified frame 206 for mounting the print bed assembly 205 in the illustrated vertical orientation. As the modification, frame 206 comprises two bars 210, 212 spaced apart in the horizontal z-axis, and both arranged parallel to the y-axis, having 40×40 and 20×40 T-slot aluminum extrusion profiles. Bars 210, 212 can be bolted to an existing frame of the printer 220 using steel plates and fasteners. The purpose of this frame modification is to allow the printer 220 to rest perpendicular to its standard position, as well as allow for sufficient clearance between the ground and moving components of the printing apparatus 200 (e.g. the moving hot end assembly 204). However, the printer 220 does not need to be mounted in this vertical orientation. The success of the 3D print job is substantially indiscriminate of orientation (as described previously). As such, print bed assembly 205 can be mounted in any orientation that is not the standard horizontal orientation but which leverages gravity for automatic removal and collection of the part, including vertically as shown in the FIG. 2 embodiment, or at an incline to the horizontal.

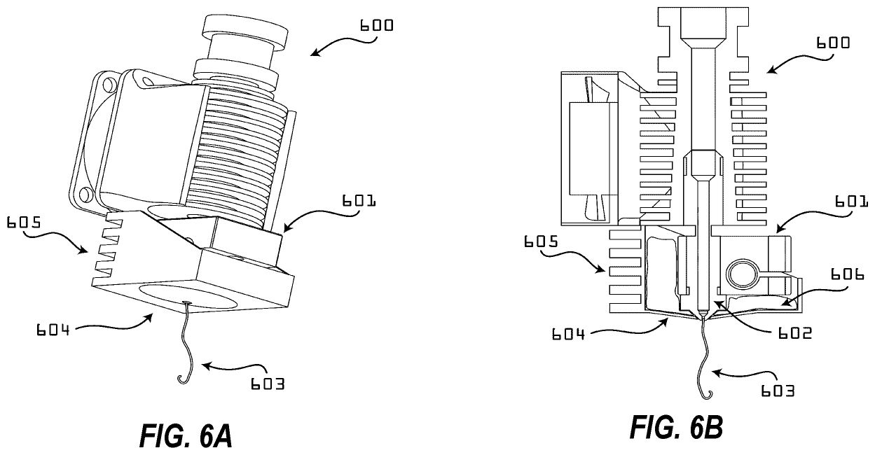

In alternate embodiments the print bed assembly 205 may be mounted “upside down” (i.e. rotated about 180 degrees from its standard horizontal orientation so that the nozzle of hot end assembly 204 is facing up) or at least partially upside down (i.e. rotated over 90 degrees and under 270 degrees from its standard horizontal orientation) (collectively, “inverted configurations”). In these inverted configurations, during temperature ramping or idle periods, small amounts of plastic may be pushed out of the heated nozzle due to back pressure, and may build-up around the nozzle over time since gravity is pulling the plastic back down toward the nozzle. This build-up of plastic can cause problems, such as combustion during a higher temperature print; getting caught in an ongoing print and leading to imperfections or print failure; interfering with electronic components on the hot end assembly 204; and blocking airflow and impeding operation of the cooling system which can eventually lead to catastrophic failure of the hot end assembly 204. In particular embodiments having the inverted configuration, hot end assembly 204 may be equipped with features to mitigate plastic build-up around the nozzle end. For example, features to mitigate plastic build-up may include one or more of: a shield to deflect the plastic away from the nozzle of hot end assembly 204; a self-cleaning tool (e.g. a brush and collection bin affixed within the nozzle's range of motion); or moving the hot end assembly 204 by the printer over the brush to knock off any plastic that resides on the hot end assembly 204, and the like. One or more of such features may also be provided for a hot end assembly 204 of a printer 220 adapted for use in a non-inverted configuration, since plastic build-up around the hot end can be a problem as well in other configurations. A hot end assembly 204 incorporating anti-excess plastic buildup features is described below with reference to FIG.6.

FIG. 6 shows a hot end assembly 600 having a heating block 601. The heating block 601 incorporates a heater and aluminum block, and spreads heat around the nozzle 602. Excess (filament) material 603 may ooze or leak from the nozzle 602 while the hot end is heated. Leakage occurs while the nozzle is lifted away from the print surface, typically when the hot end is ramping up temperature or is in an idle state. Shielding 604 is provided around the nozzle to deflect any plastic leakage that may come toward the hot end. In the illustrated embodiment, the shield incorporates head dispersion fins 605 over which air may be blown. Shielding 604 may be made of metal. If the shielding 604 is metal, its temperature should be maintained below the melting point of the extruded material so that if they come in contact, any molten material would cool and no longer be sticky. If the shield were too hot, the extruded material would stick to it readily. An insulating buffer 606 fills the cavity between the heat block and the shield. It prevents the shield from being warmed. The insulator could be composed from fiberglass or mineral glass

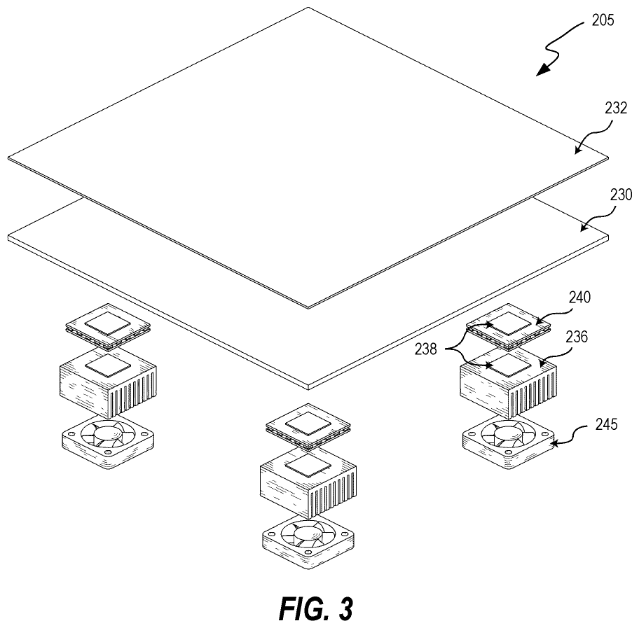

As best seen in the exploded view of FIG. 3, the print bed assembly 205 comprises a platform 230 and a print surface 232 disposed on the platform 230. Molten plastic from the 3D printer nozzle is extruded directly onto the print surface 232 (i.e. no additional surface coating is necessary). The print surface 232 can be attached to the platform 230 by way of clips (not shown) along the perimeter, or by providing an adhesive layer (not shown) between the platform 230 and the print surface 232, or by other suitable means (e.g. magnets). In particular embodiments, the platform 230 comprises a plate made of a material with good thermal conductivity, such as aluminum or copper. The plate acts as a heat spreader to ensure even heat distribution over the print surface 232. Platform 230 may also have an integrated resistance heater in some embodiments. In the illustrated embodiment of FIG. 2, the platform 230 sits on the y-axis carriage of the printer frame 206, allowing the print bed assembly 205 to be optimally positioned for part release.

Print surface 232 is engineered to have adhesive and part-releasing capabilities when temperature is changed. In particular, the printing surface 232 that is applied to the platform 230 has properties that, with a change in temperature of the printing surface 232, enable a change in the level of adhesion of the printing surface 232 to the deposited printing material. These properties include, for example: a change in surface energy of the print surface, a consistent surface energy in the print surface coupled with a change in surface energy of the deposited material, a change in surface geometry, or some combination of the above properties. To create a suitable print surface material, one or more of the following factors are considered: the surface energy, change in surface energy with temperature, thermal expansion, and melting or decomposition point of the print surface material.

In particular embodiments, a function of the print surface material is that at one temperature, the adhesive force (also referred to as interface force) between the deposited material and print surface is sufficiently high to allow the deposited material to adhere to the print bed, while at another temperature, the interface force is lowered sufficiently that the part can be removed with minimal or no intervention (e.g. through one or more of: gravitational force by orienting the print bed vertically or at an incline to the horizontal, performing a mechanical sweep of the print bed, and vibrating the print bed). The interface force required for adhesion to the print bed will vary according to various factors, including for example, the orientation of the print bed and the shape of the object. The temperature at which the print surface adheres to the deposited materials is higher than the temperature at which the part is released. As the temperature decreases, the surface energy of the print surface and the surface energy of the bottom layer of the deposited material change such that the contact or interface force between them crosses a threshold where it is no longer strong enough to overcome gravity's effect on the deposited model (or the effect of a mechanical sweep of the bed). When considering the print surface material only, its surface energy preferably crosses that threshold within normal FFF operating temperatures (e.g. between 10° C. and 150° C.), although modifications can be made to the print bed to enable adhesion/release outside of these normal operating temperatures where the material crosses the threshold at such temperatures (the upper limit to that range would be constrained by the type of deposited material—for example, the operating range of the print bed should be below the temperature at which the deposited material would start to burn).

The surface energy of a material affects the behavior of liquids that come into contact with the surface. A material with high surface energy (such as metal or glass) will cause liquids to cling and spread easily across the surface. By contrast, materials with low surface energy (such as polyvinyl acetate or polytetrafluoroethylene, e.g. Teflon™) cause liquids to bead up and roll off. As the print surface 232 is heated, its surface energy increases. Meanwhile, the heated print surface 232 creates a semi-molten interface of deposited thermoplastic between the bottom of the printed part and the remainder of the deposited model 250. The high surface energy entices the molten plastic to wet to the print surface 232, providing a strong bond for the base of the deposited model 250.

Based on tests performed on embodiments of the print bed assembly 205, there may also be a strong electrostatic attraction between the deposited model 250 and the print surface 232 in some cases. The electrostatic attraction may be related to microscopic action at the surface between the two good insulating materials. When the print surface 232 is cooled, the surface energy decreases, and the base of the deposited material solidifies, removing the wetting action between them.

In some cases, it is not necessary that the print surface undergo a change in surface energy. For example, the surface energy change in the deposited material as it is solidifying when temperatures are lowered may be enough to facilitate release of the deposited material from the print surface.

The deposited model 250 and print surface 232 generally contract at different rates, which may introduce a mechanical tension that can help to disengage the deposited model 250 from the print surface 232. When the print is finished and the bed allowed to cool, the change in the surface geometry that interfaces with the base of the object is so great that the part loses its “grip” and is overcome by gravity (or some other force applied to the part, e.g. mechanical sweep) and is released from the print bed. The reason this works is that if the surface is around the glass transition temperature of the deposited material, the molten plastic being applied to it will readily flow into and tightly conform to the microscopic features of the surface. The larger area of contact between the molten plastic and the surface, the higher that interface force is. When the bed starts to cool, not only does it contract and change the surface geometry, the plastic that was on it begins to solidify and cannot morph to the change. Despite being mechanical, this phenomenon is related to a change in surface energy as the interface force between two objects can also depend on geometry and amount of contact between them. An example of a print surface that utilizes this phenomenon is a sheet of glass with a ceramic pattern embedded to the surface. The ceramic pattern consists of grooves and valleys which the deposited plastic grips when hot.

Suitable print surface materials that exhibit the properties described above may include: glasses, ceramics, enamels, epoxies, resins, some thermoplastics, copper, aluminium, polyamide, phenols, tin, zinc, lead, and stainless steel. Certain materials may require a particular surface texture in order to adhere to the deposited material at higher temperatures and release from the deposited material at lower temperatures. For example, copper and aluminum may have a polished surface. Other materials may have a surface engraved with a particular pattern, such as a pattern of grooves and valleys, as described above.

In certain embodiments, the print surface 232 comprises glass-reinforced epoxy laminate material. This is a composite material comprising woven fiberglass encased in epoxy resin. For example, print surface 232 may be a sheet of FR4-grade or G10-grade glass epoxy. These materials are generally cured under high heat and pressure and are durable materials with good strength to weight ratio. FR4-grade glass epoxy also has flame-retardant properties. FR4-grade glass epoxy sheets typically come in thicknesses ranging from 0.5 mm to 25 mm. FR4-grade glass epoxy sheets having a thickness in a range of 0.5 mm to 3 mm are used as the print surface 232 in particular embodiments. The sheet of glass epoxy is cut to match the size of platform 230. While the use of flame-retardant properties and glass-reinforced materials is beneficial, it is not necessary to use materials having such properties to obtain the desired temperature-dependent adhesive performance of the surface material 232, as described above.

Under general, non-heated circumstances glass-reinforced epoxy laminate materials do not provide adequate adhesion to the deposited model 250. However, once heated, the bond between the epoxy print surface 232 and the initial layer of the deposited model 250 is comparable to the bond achieved with other print surface coatings. The level of adhesion between the epoxy print surface and the initial layer of the deposited model is a function of heat. More specifically, when the print surface 232 is heated to a point within a certain range of the glass transition temperature of the printing material being deposited, it provides a very strong bond to the printing material. When the print surface 232 and the deposited model 250 on it are cooled, the bond between them is broken and the deposited model 250 can be removed with ease.

With very light models (especially those with large base surfaces or footprints), the residual static cling can cause them to remain stuck to the print surface 232. In those situations, a quick pass with the hot end assembly 204 (serving as a part pusher in that situation) can dislodge the deposited model 250. The static cling is localized to where the deposited model 250 is in contact with the print surface 232, so a small translation of the model 250 is generally sufficient to overcome the attraction. In alternate embodiments, a static eliminator may be used to remove the cling.

For example, one or more of the following methods may be used to overcome static cling:
vibrating the print bed after cooling of the print bed so as to cause the part to be dislodged from the print bed;
an ion gun, which can be used to deionize charged surfaces, can be used to mechanically dislodge the part and eliminate any static cling that causes the part to stick to the print bed. Such ion guns may include a compressed air nozzle with an ion generator;
a small air-blade or compressed air nozzle can be mounted to the effector assembly. If the part remains stuck to the bed after cooling, the air blade generally provides sufficient force to dislodge the part;
one or more anti-static compounds can be mixed into the epoxy that is used for the print surface and/or can be applied to the print surface;
a high voltage can be applied to a heat spreading layer under the print surface. The high voltage can repel the charge captured in the part, or overpower the charge between the part and the print surface and cause the part to be released from the print surface;
a high voltage probe can be placed along the front side of the effector. This has the benefit of concentrating the voltage in a small area that is directly in contact with the part. This is generally a safe and easy-to-implement method for overcoming the static cling effect; and
a grounded strip can be placed across the effector to dispel any discharge that has built up in the object it contacts.

To automatically remove the printed part from the printer, a reset procedure can be performed upon completion of the printing. In particular embodiments, such as for the embodiment of FIG. 2, this reset procedure comprises homing the x, y and z-axes and positioning the print bed assembly 205 at its extreme position along the y-axis so that ejected printed parts can clear the frame 206. Additionally, the print bed is allowed to cool (and/or actively cooled), and once the detaching (threshold) temperature is reached, the printed parts detach from the print surface 232 and drop toward the ground. The parts may be collected in a collection system below. In some embodiments, the hot end assembly 204 is swept across the print surface 232 (and/or the print bed is vibrated) to ensure the bed is clear for the next print. A final check may be conducted via machine vision, wherein a printer camera provides images to a central print control and management service (as described in further detail below) for the detection of discrepancies compared to a baseline image of the bed. Once all parts have been confirmed to have been removed, the printer 220 is placed in standby mode for the next job.

In some embodiments, the print bed is allowed to cool by shutting off the print bed heater and allowing the heat to radiate from the aluminum sheet. However, in other embodiments, cooling mechanisms are provided to hasten cooling of the print bed and reduce the time required for the reset procedure. Decreasing the cooldown time not only increases the efficiency of the overall system, but can increase thermal shock which assists with part removal. In the illustrated embodiment, such cooling mechanisms include aluminum heatsinks 236 attached to the underside of the build platform 230 with double-sided thermally conductive adhesive 238 (see FIG. 3), and active cooling for quick temperature cycles facilitated by Peltier tiles 240 adhered by thermally conductive adhesive 238 to the underside of the platform 230. Peltier tiles create a temperature gradient when voltage is applied to them, and act as a heat pump. During cool down, the cooler side withdraws heat from the platform 230 and the warmer side dissipates heat through the heatsink 236 with the help of a heatsink fan assembly 245 placed on the other side of the heatsink 236. Peltier tiles reverse the temperature gradient when the applied voltage is reversed, so the cooling assembly provided by these Peltier tiles can also be used to supplement the heating phase.

Since different printing materials adhere and release at different temperatures, temperature cycling can be optimized per material. Data can be collected about material type, cooldown time, the threshold temperature at which parts release, the temperature at which parts are printed, and the first layer success rate of parts printed at each temperature. This data can be used to generate part removal profiles for each printing material. The smaller the temperature range, the faster the reset process can occur.

Another aspect of the invention provides a central print control and management service for coordination of 3D printing among a networked group of 3D printers outfitted with the automation hardware and mechanisms described herein. The 3D printers are configured to draw print jobs from the central print control and management service. In particular embodiments such service may be implemented as a cloud-based (also referred to as cloud computing) service delivered through one or more servers of the service provider. Each printer is outfitted with an Internet-enabling controller for processing instructions arriving from the cloud computing provider's servers. The service is implemented through software executed on the cloud computing provider's servers. The software can include the following modules, each implementing a main function: (i) remote printer control, (ii) print job delegation, and (iii) print job scheduling. Other modules or functions of the software may include: failure detection, ongoing quality checks, inventory management, automatic filament setting generation, and print packing. Data concerning printer status is aggregated from the network of printers and is used to inform the functions executed by the servers. Certain parameters are applied by the functions to determine compatibility and timing of the print jobs, as described in further detail below.

Therefore, instead of directly interfacing with the printers, a technician submits a print job to a central print queue managed by the central print control and management service. The technician can input parameters such as quality, colour, priority, material type, etc. when submitting the job order. Based on these parameters, and those of the jobs already residing in the queue, the print job scheduling component determines when the job is to be executed and what printer it will potentially use. Printers connected to the network are assigned a volume, nozzle type, material type, and colour. An estimated print start time is calculated for each job based on its position in the queue, the length of preceding print jobs, and current availability of compatible printers in the network. An earliest possible print date is also estimated for jobs set to maximum priority.

In some embodiments, the service accepts a due date as one of the parameters provided by the technician. The print job scheduling component manages the queue to ensure that the print jobs are completed by their respective specified due dates. Jobs with longer due dates can be surpassed by jobs due earlier. To prevent low-priority jobs in the queue from being pushed back indefinitely by more urgent jobs, the priority can be adjusted over time (i.e. priority is made a function of time). In particular, the weight assigned to a job (wherein weight is indicative of priority) can increase over time to prevent a network with multiple users from constantly overriding each other. The weight of old jobs may eventually exceed the maximum assignable weight; in such case, the earliest possible print date for new jobs is bumped back to allow the old jobs to proceed. Since the type of printing material loaded into any given printer (and in some situations, the number of printers available) can change, time estimates for print jobs can also fluctuate, which is factored in by the print job scheduling component to some degree. Orders receive a time estimate based on the current schedule.

In particular embodiments, the queue is structured so that 3D printers that can accept the same type of job are grouped and pull from an ordered list of compatible jobs as they become available. In this manner, the main queue is broken up into a plurality of smaller lists based on job settings. The print job scheduling component may be configured to generate recommendations as to how many printers should be loaded and with what material to complete the current master list of jobs most efficiently. To further increase efficiency, if there are multiple smaller prints in the same material, the print scheduling component can optionally cause them to be packed onto the bed in a single print job rather than printing each individually. This may save time as the reset procedure needs to be run only once for that batch of jobs. Print packing may also beneficially increase or maximize material usage per volume. However, a potential trade-off is that packing multiple parts onto a print bed can result in longer print time or mean a greater loss of printing material in the event of a print failure. As such, the packing of multiple parts can be made an optional feature that is elected by the user or that is performed as a result of a determination made by the print scheduling component having regard to various considerations.

Print packing is a bin packing problem, for which the computational complexity may be considered to be NP-hard (non-deterministic polynomial acceptable problem). To prepare for print packing, the 3D models specified by a set of user inputs need to be of the same color and material. The volume of the print area is also defined. Given the set of inputs, the number of models is initially determined by considering the volumes of the objects selected to be printed. One constraint is that the sum of these volumes cannot exceed the volume of the print area. Another constraint is that the sum of the bounding box volumes of all the objects in consideration should not exceed the print volume. This analysis may introduce inefficiencies but yields an initial estimate of the number of objects that can fit in the print area.

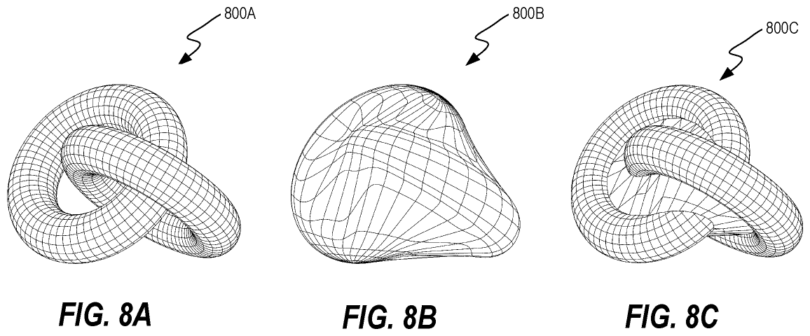

A further constraint for valid print packing is that no models should be intersecting and they should fall within the print volume. The traditional method of detecting intersection, by examining whether the surface of the models contact or intersect, may let undesirable print packing cases slip through, such as the case of one torus or ring printed perpendicular to a second torus or ring and such that one passes through the other, like links in a chain, as shown by the scenario 800A in FIG. 8A. While they would meet the non-contact test, the tori would be inseparable from one another without breaking one of the tori. Another example of an undesirable print packing case that would meet the non-contact test is a hollow sphere printed with another model within it. To avoid these undesirable cases, rectangular prism bounding boxes may be used for each model. However, this approach would inhibit optimal packing. To improve packing efficiency, while avoiding undesirable print packing cases such as those described above, one approach is to generate a genus zero version of the model mesh to check for intersections. Using this approach, holes would be covered, preventing interlocking parts, and nullifying the extraneous cases.

In some cases, the intentional linkage of parts is desired. Generally, the set of intentionally linked parts would be arranged in advance and contained within a single imported model or assembly, as shown for example by model 800A in FIG. 8A. As seen in FIG. 8B, a single genus zero bounding mesh 800B is generated for the group of parts that reside in that job, such that the linked parts persist. Alternately, each imported file or assembly may have a “shrink-wrapped” bounding mesh 800C, as seen in FIG. 8C, to allow for tighter packing of parts, as it constrains less space to the model.

Some methods involve the random generation of valid configurations of models which meet the constraints noted above (e.g. sum of these volumes cannot exceed the volume of the print area, sum of the bounding box volumes of all the objects in consideration should not exceed the print volume, no models are intersecting and that they fall within the print volume). Each configuration is evaluated based on density and the configuration that yields the highest density is selected as the print packing configuration. However, these methods may be slow and yield poor results, since they probe random points and select the best one of these random points, and do not actively approach any maxima in density function. There is a need to generate better solutions faster, and inquire as to what regions of the solution space can be removed. Improved methods which optimize the solution generation method and reduce the solution space are discussed below.

Since the slowest print direction is generally along the axis in which the print layers are stacked, one method involves minimizing the height along the Z-axis. Once the Z height is minimized, the next task is to minimize the spread of objects in the X and Y direction, to increase the part density. Since there is a strong correlation between part density and overall job length, minimizing the Z height and the X and Y spread will also reduce the overall job length.

Optimizing position when packing 3D models is computationally expensive. A single algorithm can be used, applied on increasingly smaller scales. Alternately, a coarse approach may be used initially to approximate the best solution, and more computational expensive algorithms may then be used from there to refine the solution.

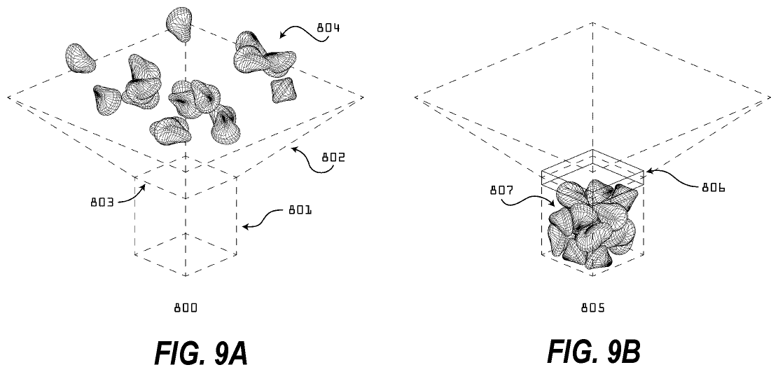

In one embodiment based on physics-based packing, the coarse approach may involve running a rigid body simulation of the models' bounding meshes for a given print volume. Referring to FIGS. 9A and 9B, simulation representation 800 shown in FIG. 9A is an example initial state of the simulation and simulation representation 805 shown in FIG. 9B represents an example end state. The packed print volume, represented as a rectangular prism 801, may be constructed as five solid planes: four forming the sides and one forming the bottom. A funnel 802 extends around the top edges of the prism 801. A group of models 804 is randomly arranged above the funnel. In the simulation, these models are pulled from the print queue. The number of models pulled from the queue depends on the sum of their bounding mesh volumes. The total bounding mesh volume needs to be less than the print volume 801; thus the print volume provides a hard cut-off to the number of models pulled from the print queue. Parts pulled from the queue may be arranged based on priority, and allowed to fall (under the effect of gravity) into the print volume based on their priority. The funnel 802 and volume 801 are then shaken randomly in the XY plane to settle the parts. Alternatively, the parts could be assigned a “temperature” that slowly decreases over a period of time. The temperature value of a model indicates a level of vibration. For the purpose of settling, it may be desirable to limit the direction of vibration to the XY plane. During this process, the gravity of the system may be steadily increased, slowly constraining the models as the force required to move them increases. After a certain point, any excess models sitting outside (above) the print volume boundary 803 are deleted from the simulation. In this example—as models that come from the queue have an associated priority—models are deleted starting from lowest priority until the remaining models are able to fit within the volume. Deleted models are returned to the queue. Finally, a collision plane 806 may descend along the Z axis, compacting the models into the print volume. The resulting model positions and orientations 807 are passed along to the finer adjustment algorithm. In some cases it may be desirable to repeat the simulation with randomized model starting positions and select the best result.

In some embodiments, simulated annealing can be employed to approach an approximate maximum packing of models. Models can be randomly arranged within the print volume and the resulting configuration may be assigned a packing score based on the ratio of model volumes to the overall bounding volume (e.g. the volume calculated in the same way as for a single model, such as the same “shrink-wrap” process as described above). The packing score assigned in this manner can be based on model density. It is noted that the ratio is not being compared to an overall print volume, even if the entire print volume is not consumed, as achieving maximum part density is desired. The packing score is a function of all valid model configurations within the print volume, in which simulated annealing techniques can be used to approximate a maxima for the function.

This approach seeks to obtain optimization by exploring the function through semi-random probing, and probabilistically converging on a maximum or minimum given a finite period of time. As time elapses, the probability of considering less favourable solutions decreases. In some embodiments, the optimization procedure can incorporate an image, an evaluator, and a solver.

The image is a virtual representation of all the models and the print volume. Models are manipulated around this space. The final image generated can be exported as a 3D model and converted to a print job. In some implementations, this image can be informed by the solver. The evaluator is operable to carry out an evaluating function that scores the density of the current configuration of models in the image. The solver can be configured to implement the simulated annealing heuristic as well as a means of interpreting results in a way that informs the image where to position the next iteration of models.

During each iteration of the simulated annealing procedure, for a certain image, some change can be made to the position of the models. The efficacy of that change may be evaluated. It is then decided whether to explore similar (i.e. neighbouring) configurations of models, consider an entirely different configuration, or revert to a previous configuration and explore further. The difference between configurations at each iteration (e.g. differences measured in distance from the previous model positions and angles) is expected to shrink over time, initially starting out with a wide variety of configurations, and slowly collapsing toward a single solution.

To increase the likelihood of finding an optimal solution, solution space pruning techniques can be employed to prune the search space (or solution space) of known sub-optimal areas. By default, the search space includes all possible selections of parts in all positions in any orientation. At a first instance, the search space can be restricted to the print volume and by a predetermined selection of models. For example, the selection of models can be made either by the users selecting them directly or assigning the parts priority by placing them in a queue.

In addition to the foregoing, adjustments can be used to narrow down the solutions to be explored. Exemplary adjustments are briefly described in turn, in which one or more adjustments can be used.

A coarse adjustment, as described above, can be implemented since it is a less computationally expensive method that can be used to reach a starting state or set of starting states that are already reasonably optimized.

The solution resolution can be defined to reduce the vastness of a continuous 3D solution space. The resolution can be used to specify what is the minimum amount of difference required for two solutions to be considered different. This difference can also be considered as the minimum increment or step each object must be moved. The parameters for minimum step can be given in terms of mm for an XYZ coordinate space and degrees for angle (in XYZ).

A minimum density bound can be imposed. In some cases, it may be suitable to immediately discount configurations below a certain packing score. For example, if a configuration has a density of 0.1, it is generally unlikely that making any minor adjustments would suddenly cause a jump in that packing score value. The overall density of the system normally changes gradually with the position of the models so it is also unlikely that any neighbouring states would result a good score. Even if the models themselves are below this threshold (e.g., a low-density sponge-like mesh) it may not be a concern, since only the bounding mesh is being compared. The bounding mesh generally would not allow any internal hollow areas, essentially creating a 100% density version of the model. This way, only the space between models is what is considered, and the actual structure can be ignored.

A Z height bound can be imposed on physics-based (and potentially other) coarse model placements to help minimize height along the z-axis. In some cases, it may be useful to maintain a low Z height in terms of print time. To obtain this goal, it may be desirable to restrict any solutions generated by the fine adjustment algorithm to stay at or below a Z height by setting a Z height bound. In some cases, a tolerance could be included to allow increasing the overall Z height to a certain extent, but a trade-off between minimum height and density may have to be made in some cases.

Some forms of 3D printing are anisotropic, and to preserve the intended properties of the printed model, users may choose to lock or restrict the model orientation so that the model is printed in the same direction in every instance. A lock orientation can be implemented by defining various parameters. For example, users may lock the rotational axes of their choice and those locked axes would be removed from consideration in one or all adjustment steps.

With some types of 3D printing, there may be no advantage to stacking models vertically. As such, a single layer or 2D packing mode can be used to narrow down the solutions in the solution space. In 2D packing mode, only prints that directly contact the print surface are considered. The models are then packed to maximize density in the XY direction.

In some cases, at the sacrifice of optimal density, it may be useful to ensure that the selection of models ends at roughly the same Z height by defining a similar height parameter. This parameter may be used to address a common limitation of most 3D printers, in which printing in the z-axis is often the slowest. For example, a long and thin model might poke out of a collection of models, contributing to the density more than it harms. This consideration may be relevant when doing single layer packing. When a model adds considerably to the overall Z height of the arrangement, removal of that model may be considered. This “excess” Z height can be detected by analyzing a 2D cross section of the arrangement along the XY plane of the entire print volume. For example, the density of parts of the cross section (i.e. sum of the cross sectional area of the parts divided by the total print volume cross section) may considerably drop towards the top position of this volume suggesting a model adding considerably to the overall Z height of the arrangement. A cross sectional density threshold can be defined so that if the density value drops below this threshold and is sustained over a long enough Z distance, the parts/models within that area may be removed.

If the cross sectional density value was a function of the cross section's position on the z-axis, the upper end of the function (representing the top of the print volume) is likely to cross zero. In an ideal packing scenario, the function would have a value near 1 throughout the domain, and quickly drop to zero as close to the right bound as possible. As discussed before, it is not necessary to fill the entire print volume, but to obtain an arrangement of parts that is relatively flat on top. One can look at the slope of the function as the function approaches 0 and determine from how steep it is to determine whether or not the arrangement of parts all end around the same Z height. Maximizing the negative slope at the end of the function helps to achieve the goal of obtaining an arrangement that ends around the same Z height.

In the case of 3D packing, this can be achieved in both the physics simulation and simulated annealing. With 2D packing, this is can be achieved by selecting from a group of models that have roughly the same height (within some threshold).

Optimizing the cross sectional density function may sometimes be at odds with (i.e. reduce) the 3D part packing density. This represents a trade-off between efficient material usage and time. Whether cross sectional density takes priority over 3D part packing density can be determined upon the current priority of items in the queue, the value of the material being used, the end value of the objects being printed, and the cost to operate the printing equipment. These considerations all depend upon the user's preferences and the type of 3D printing they are using.

Once a solution to the print packing is computed, the bounding meshes are replaced with the original models and the entire arrangement can be saved as a single 3D model for import into a slicing program.

In some embodiments, the file may be automatically sliced (i.e. converted to printer instructions or G-code) based on the settings of the content parts and sent to a printer as a single job.

In further embodiments, metadata containing the source files and the final determined positions of the part may be saved, to defer the resources for reconstruction of the model arrangement to a later time.

While the heuristic described above is not specific to FFF 3D printing, there are some implementation considerations applicable to automated part removal and FFF printing. Objects printed with FFF (and most other types of 3D printing) are anisotropic due to their construction, which may result in poor fusion between layers that introduces shear weakness in the X Y direction. For this reason, the same model printed in two different orientations could have differing mechanical properties. Printing in different orientations can also impact the printed model aesthetically. However, one aspect to note is that rotation about the Z axis generally has no effect on the integrity of the model.

For the foregoing reason, at the expense of efficient packing, the user may elect to preserve model orientation. When models are initially imported, the user can be presented with a preview that can be manipulated to a desired orientation. When the models are being considered by the part packing algorithm, their Z direction can be preserved, however they may be rotated about that axis. The solution space can also be greatly reduced as noted above, as the two axes of orientation are no longer being considered for each part.

FFF 3D printing also may not benefit much from stacking models vertically as such configurations require support structures to be added, which increases the print time (i.e. slows down print speed) and consumes more print material. For this reason, a single layer of models may be considered, all of which contact the print surface at some point (e.g. FFF 2D packing). Additionally, to optimize print speed, models of similar heights may be packed together.

Depending on the print bed orientation, the excess material used to support models further away from the bed may cause unnecessary strain on the entire model, and may in some rare instances cause errors in print adhesion due to being too heavy.

For the purpose of print job order management, a set of jobs can be tagged as being part of a single order. Where multiple different models are being printed in one order, the collection of parts can be deferred until all of the prints are complete, to improve efficiency.

The central print control and management service tracks which printers print what part, and causes to be displayed the location of a part on completion. A set of printers that share one conveyor system may be grouped as a single “output group” and all finished parts are tagged as coming from that group. This can make it easier to locate parts when jobs are no longer manually being tracked and assigned.

At the cost of efficiency, jobs grouped as a single order can be set to print in physical proximity to one another. In addition to output groups, the printer overview allows users to arrange printers as they are laid out in the factory. This enables the print job delegation component of the central print control and management service to determine where to delegate these jobs.

When a printer signals that a job is complete and that it is ready to accept a new one, the queue transfers a new print file to a local printer controller module, which communicates the print instructions to the printer. In a similar way, users will be able to access and remotely control printers through the remote printer control module of the central print control and management service, by sending individual instructions or choosing from preset scripts. To facilitate a user remotely interfacing with a printer, the printer may be outfitted with a camera in some embodiments to stream video footage to a user interface for the remote printer control module.

An advantage of managing and controlling a bank of 3D printing machines through a central print control and management service is that it automates the coordination of the use of machines among multiple users, by employing the service's remote printer control, print job delegation, and print scheduling modules. Some aspects of the automated coordination can be influenced by an administrator assigning different levels of permissions to different classes of users, so that certain classes will only be permitted to perform specific actions. Without automated coordination, a team of people is needed to manage the use of the printers among competing users. Automating the queue priority can increase efficiency in coordinating the available resources.

To facilitate automation by the central print control and management service and reduce the amount of manual setup and maintenance required, a filament detection system is provided in certain embodiments, identifying the type of printing material that each printer has been loaded with. One method of identifying the type of printing material involves providing filament spools with passive data storage chips containing a universal code identifying the printing material type. For example, each spool may contain a Near Field Communication (NFC) chip containing a material identification code. When the filament 225 is loaded onto the spool mount 201 of the printing apparatus 200, a reader on the printing apparatus 200 automatically detects the identification code and reports it to the central print control and management service. The service looks up the code in a table in a database and, based on the information in the table, identifies the filament type. In some embodiments, one or more of composition, weight, date of manufacture, and batch or production number is linked to the filament identification code along with the filament type. If any of these parameters for a filament type is changed, the filament is assigned a new identification code.

Data regarding the settings and temperatures used for each filament type can be collected from across the network of 3D printing machines to establish an average or baseline setting for the printing material. The failure and success rate of prints assigned certain setting ranges can also be considered. The objective is to populate an open database of different material types with their average optimal settings. If a user decides to begin using a new type of printing material for their 3D print farm, print settings would be auto-populated with what worked for the multitude of other users who have already gone through the troubleshooting process for the same material. At that point it is expected that workable print settings have been generated, which obviates the need for coarse adjustment for the printing material and enables the user to proceed directly to making finer tweaks specific to the model being printed. The process of developing print setting profiles for each material is distributed over a large network of printers that have provided hundreds of hours of concurrent testing, resulting in the determination of optimal print settings. Thus, 3D printing with new printing materials (which are new or unfamiliar to the particular user) becomes largely a drop and print experience. In certain embodiments, a database of user-registered filament types is maintained for users to manually enter the filament name, type, colour, and other information, to assist with identifying filament types and auto-population of print settings for different filament types.

In some embodiments, a load cell is integrated in the filament spool mount 201 to keep track of the change in filament weight over time. The objective is to avoid sending large prints that will deplete the spool halfway through. If a print runs out of filament printing material 225, the model is at risk of failing or suffering a major defect even if new filament is loaded in time. In some printer configurations, the print material is feedstock in the form of pellets or other plastic inputs rather than a filament spool. In this case, the load cell can be placed in a suitable hopper or input capable of measuring the weight of the remaining feedstock to track its consumption over time. While certain measures can be taken to mitigate these issues, as discussed below, in some situations it is preferable to avoid interruptions where possible. The load cell also enables the generation of advance warnings when filament is running low, so the technician can prepare their next round of restocking beforehand, rather than after the filament is out.

Information concerning the filament weight is transmitted from the load cell to the central print control and management service. Where the remaining weight of filament detected by the load cell is insufficient to complete a particular print job, the central print control and management service re-routes the job to another printer which has sufficient printing material. This capability can be toggled on or off, as re-routing restricts the printer's pool of possible jobs, and in some cases, it is not feasible to leave a printer on standby for the sake of using filament efficiently. In some embodiments, thresholds can be made adjustable in accordance with the circumstances. For example, if exclusively 700 g models are being printed, and the threshold is set at 700 g, 1 kg spools of filament would be suspended after only a single print; in such a case it may make more sense to allow for models to be partially printed with the remaining 300 g and wait for an exchange. This would be desirable for long periods of unattended printing, where the time can be used to fit in as many completed models as possible out of each spool.

As filament comes on spools of various shapes, the load cell would not be able to ascertain the exact weight of usable material. The amount of material can be estimated as there are specific weights that filament is commonly sold at (i.e. a reading of 1104 g can be assumed to be a 1 kg spool). The system keeps track of weight change; when the reading from the load cell is roughly 1 kg less, the system will generate a warning. However, this system does not detect when a spool of filament has run out. Other mechanisms can be used to detect when filament has run out, as described below.

To detect when a filament has run out, in the illustrated embodiment of FIG. 2 a filament sensor 203 is provided in the printing apparatus 200 upstream of the extruder and in the path of the filament of printing material 225. When the filament is passed through or near the sensor 203, it causes the actuation of a microswitch, completing a circuit that indicates the presence of filament. This switch is used to signal that a printer is loaded and ready to print. It is also used to detect when filament runs out. The absence of filament will trip the switch of sensor 203, thereby causing the printer controller to generate a signal to pause the printer and notify the client that filament must be replaced.

The requirement to replace filament can be triggered either by the sensor 203, as described above, or by the user reassigning, through software, a different material to be loaded in the printer. In either of these scenarios, the printer will automatically extrude a length of filament to purge any old material before printing with the new material. The purpose of purging is to prevent different materials from ending up in a functional print during the transition between materials. Mixed plastics can cause malformations, deformities or failures in printed objects. The purge process preferably occurs with the nozzle positioned away from the bed (by approximately 10 cm, for example) so that the printing material drops directly downward, without getting caught in the printer's moving parts. A separate collection bin can be provided for collection of the purged printing material or the material can drop down into the same collection system that is used to collect the finished parts.

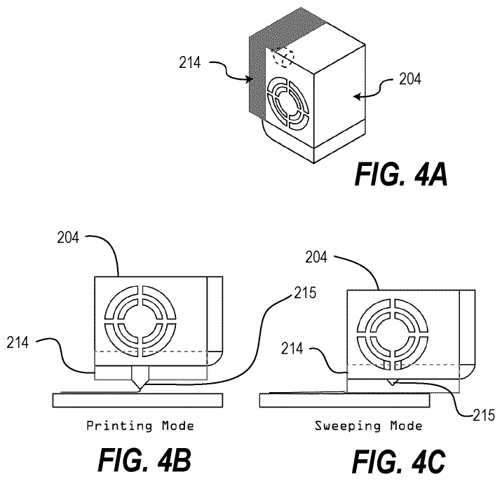

As seen in FIGS. 2 and 4, to assist with the removal of parts after a print job, a plate 214 is coupled to the side of hot end assembly 204. Plate 214 can be used to engage with and sweep parts that are stuck to the print surface. Plate 214 may be made of a flexible material. It is set back from the tip of the nozzle so as not to interfere with the deposited model 250 during printing. During the print bed resetting process, the hot end assembly 204 is moved toward the print surface, so that plate 214 makes contact with the printed parts as the hot end assembly 204 is swept across the print bed to dislodge any stuck parts. Thus, instead of impacting the nozzle of hot end assembly 204, the part makes impact with the plate 214 and the nozzle is protected from damage that might otherwise result from impact with the printed parts.

A constraint of retrofitting hot end assembly 204 with a plate 214 as shown is that the plate 214 is generally unable to contact the print surface directly, since the nozzle would meet the print surface first and prevent further movement of the hot end assembly 204 toward the print surface (see FIG. 4B). Due to this constraint, thin printed parts may slip under the plate 214 without making any contact with the plate 214 during a sweep of the print bed by the hot end assembly 204. As such, the plate 214 may not be able to sweep all parts off the print surface. One solution to this problem is to make the nozzle or hot end retractable so that it can be retracted into the hot end assembly 204 following a print (see FIG. 4C), giving the required clearance for the plate 214 to directly contact the print surface and remove thin parts.

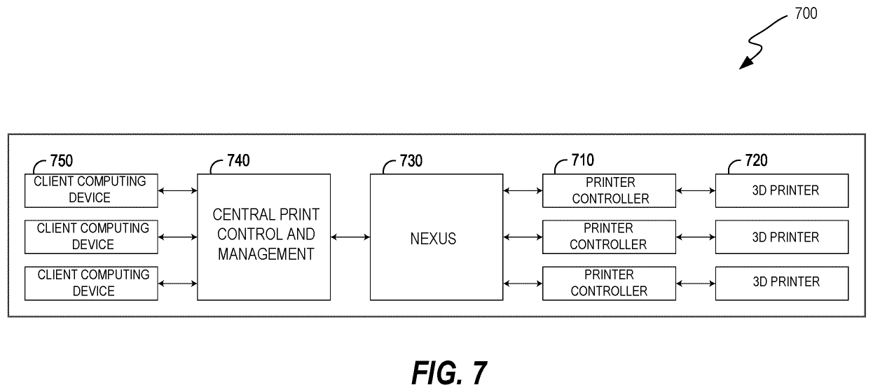

As best seen in FIG. 7, which is an embodiment of a local system 700 for a print farm, each 3D printer is controlled by a printer controller 710. In particular embodiments, the printer controller 710 interfaces with the printer's 720 existing internal controller (mainboard) over USB (Universal Serial Bus). The printer controller 710 enables wireless communication with individual printers 720. Each printer 720 uses a printer controller 710 to connect to the overall system 700. In certain embodiments, the printer controller 710 relays commands sent to it from the system 700 over a wireless connection to the printer 720 using standard G-code protocol. Additionally, the printer controller 710 has functions that filter and process data from the printer 720 to a more useful form for distribution to other functions in the system 700. The functions of the printer controller 710 are described in more detail below.

The printer controller module 710 may be implemented using a small single-board computer, such as the Raspberry Pi or RPi computer. In particular embodiments, the computer is provided with a built-in WiFi chip. The computer may be mounted to the frame 206 of the printer 220 of FIG. 2 (the computer is not shown in FIG. 2). A USB cable connects the computer to the printer's 720 mainboard. In other embodiments, wireless functionality is integrated on the printer's 720 mainboard, and printer controller 710 functions are moved to the firmware level to remove the need for additional hardware.

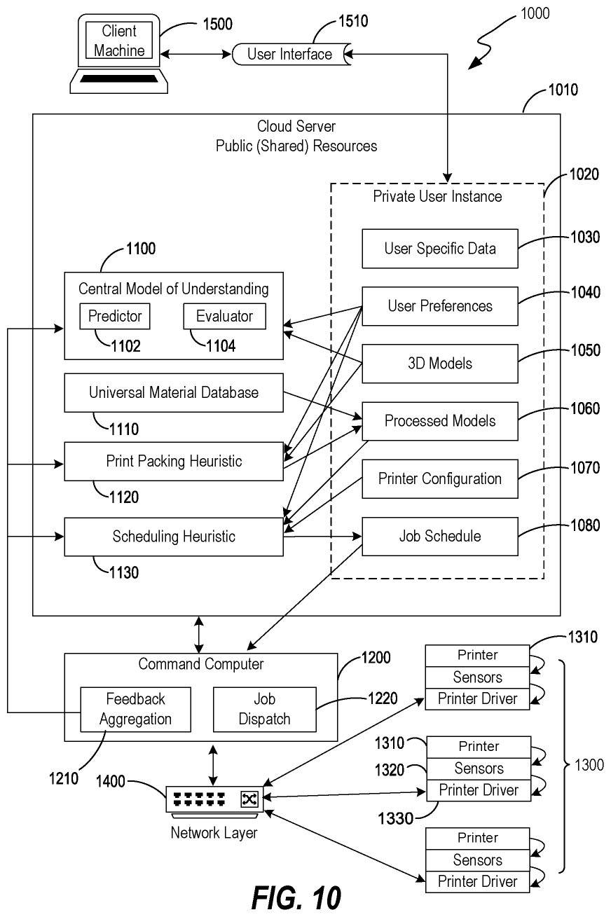

In another embodiment, the system 700 of FIG. 7 can be implemented using cloud-based infrastructure. An example of such an implementation is depicted in FIG. 10 which is a schematic representation of a cloud printing system 1000. A cloud server system 1010 may be configured to implement the software modules to automate a 3D printing workflow. A private user instance 1020 can be defined for one or more users of the system 1000 to specify printing parameters and/or manage a print job. A command computer 1200 may be provided to send commands to one or more 3D printers 1300 in communication therewith via a network layer 1400 to process print jobs. Users may access the cloud server 1010 to submit job orders or manage the system 1000 via a suitable client device 1500 such as a computer or tablet device. A user interface 1510 such as a software application user interface (API) may be provided to enable the user to access the resources available in the cloud server 1010 such as the private user instance 1020.

In the present embodiment, the private user instance 1020 includes user specific data 1030 and user preferences data 1040. A repository of 3D models 1050 for storing user models is also provided. Models that have been processed (e.g. sliced models or arrangements of models packed in an optimized manner as described above) by the system 1000 may be stored in a processed models module 1060. Printer configuration 1070 stores configuration parameters and/or print settings for the one or more printers 1300 in communication with to the cloud server system 1010. A printer job schedule 1080 is a record that may be used to store printing schedules for printing parts. The arrowed lines indicate the direction of data flow.

The cloud server system 1010 includes various modules including the CMU 1100 introduced above and will be described more fully below. A universal material database 1110 is available for storing information such as printing material profiles that describe the physical characteristics of one or more materials that are used by the system 1000 to print parts and printing data collected from printer sensors 1320. The information saved to the universal material database 1110 can be used by the processed models module 1060. A print packing heuristic module 1120 may be used to optimize packing of the 3D models, using methods and approaches described above. Also noted above, when a solution to the print packing is computed, a single 3D model reflecting this optimized print packing may be outputted to the processed models module 1060, for example, for import into a slicing program. In some embodiments, the slicing program may be provided in the cloud server system 1010 or deployed in the command computer 1200 or both. A scheduling heuristic 1130 is also provided to generate print schedules, in which the schedules can be generated using information from user preference data 1040 (e.g. printing priority) and printing configuration 1070 (e.g. known performance parameters such as printing speed).

The printers 1300 include a printer component 1310, such as the printing apparatus 200 of FIG. 2, sensors 1320 for monitoring the operation of the printer, and a printer driver 1330 for facilitating communication with the command computer 1200. The printer driver may receive print instructions and/or commands generated by a job dispatch module 1200 of the command printer 1200 via the network layer 1400. As a print job proceeds, data collected by the sensors 1320 concerning the status and operation of the printer can be provided to the printer driver 1330 which transmits this information feedback aggregation module 1210 of the command computer 1200. Data from the feedback aggregation module 1210 can be provided to the CMU 1100, print packing heuristic module 1120 and scheduling heuristic 1130 for use by these modules for performing their programmed tasks. For example, the CMU may use the aggregated data to update its internal model of experience for the purposes of predicting the likelihood of print failures for a given print job and with and print settings.

In respect of the CMU 1100, the intended objective of this model is to close the loop between 3D printer input and output. The CMU 1100 is a software heuristic which can be built and maintained by the data provided from direct user input (e.g. via the client device 1500 and private user instance 1020) and data from automated observations across a large numbers of printers 1300 (e.g. collected using the feedback aggregation module 1210). This heuristic may be a central module and deployable to any supported printer. It can be constructed using 3D model inputs, slicer settings, hardware configurations, and direct measurements of outputs and environmental factors. Based on a given input part and certain printing-related requirements, the CMU 1100 can be used to suggest settings that are most likely to result in a successful print output inferred from previous experience. In a print farm setting such as the one depicted in FIG. 10, this previous experience may be aggregated into a large database of inputs and correlated with output measurements as described herein. In a cloud-based implementation, data can be aggregated and/or shared between print farms as well, as the mechanism for updating the model can also reside in the cloud. This allows for the creation of a “crowd-sourced” experience model.

Implementation of the CMU can leverage recent advances in machine learning (“ML”) and artificial intelligence (“AI”) that have given rise to self-correcting systems with increasing frequency in manufacturing. These systems can be used as a more objective (or at least centralized) model of intuition based on thousands of data points and millions of correlations, which is often beyond the capacity of any human operator. ML and Al techniques can be applied to develop evaluation models and for automating material profile generation (described below) that has a sufficiently robust understanding that balances between settings, machine configuration, environment conditions, materials, and object geometry, and desired output. For a sufficient implementation, 3D printers running such a system should be deployable at large scales allowing for a multitude of recorded outcome data and test cases.

A standardized model of understanding via ML or AI can be used to generate settings profiles for any given situation (e.g. printer variations, the environmental variations, the nature of the material, etc.), resulting in robust repeatability and more precise control over the properties of the printed part for any given external context. The “intuition” of this standardized model can be constantly trained and updated by aggregating observations made during many print sessions. Rather than having to create a set of standard profiles for each material using existing methods, the scale offered by automated additive manufacturing solutions such as the ones described herein enable ML or AI-driven development of material profiles.

In some embodiments, the CMU 1100 comprises two primary components: a predictor 1102 and an evaluator 1104. The predictor 1102 takes a fresh set of inputs (e.g. input models for printing) and determines what printing parameters, when applied, are most likely to produce a successful outcome. The evaluator 1104 outputs a score for the observed outcome based on adjustable criteria and helps determine the success of the predictor in determining printing parameters.

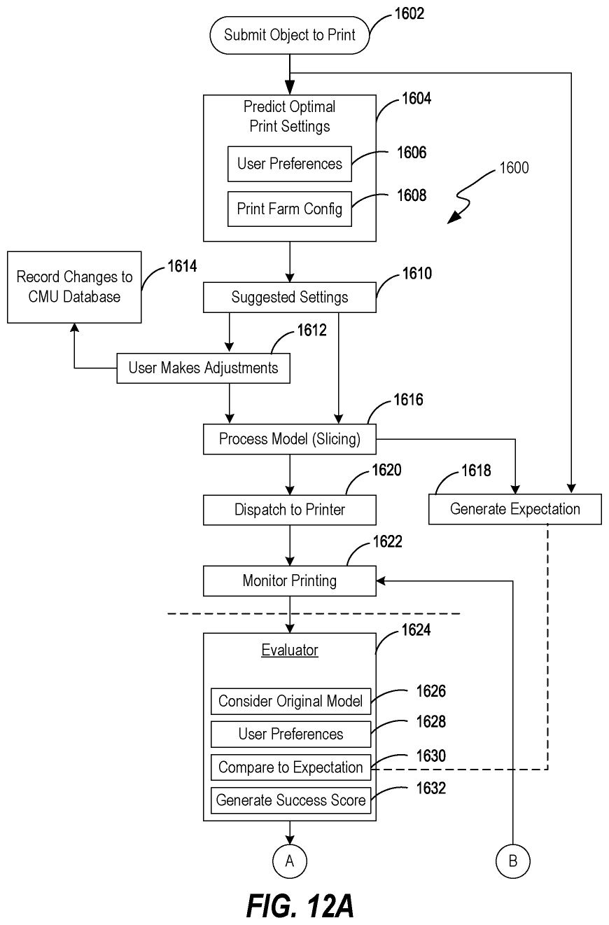

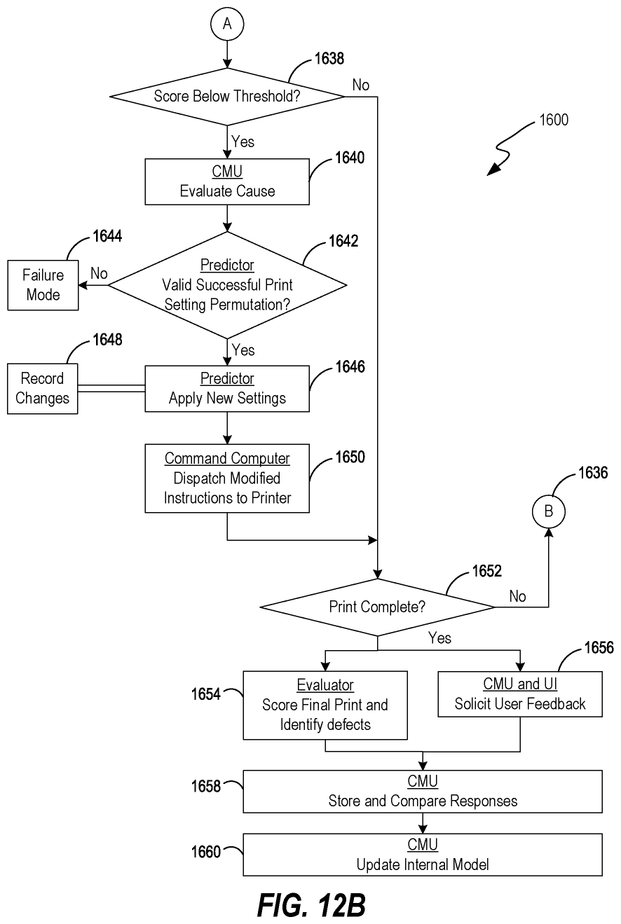

In some embodiments, the predictor 1102 takes at least a 3D model and specified material type as input to generate a set of print settings. Further information such as a use case can also be provided. For example, the use case may indicate that robustness of the printed part is favoured over print quality and the resultant parameter recommendation generated by the predictor 1102 may include settings for a higher temperature for heating the printing material, promoting self-adhesion, but sacrificing fine details. Adjustments like these are passed on to the evaluator 1104, as its criteria for judging the part must also change. In some iterations of the software heuristic, the predictor 1102 can populate the slicer with its best or optimal settings and allow the user to make further changes (which are recorded, for example, in user preferences data 1040 to update the CMU 1100), as described further with respect to FIG. 12A. In other iterations, the predictor 1102 is configured to automatically slice models when provided with a 3D file and description.

The evaluator 1104 studies the printer instructions generated by the slicer and generates an internal expectation of success. In some embodiments, this expectation can also be constructed or informed from a visual database of various parts that share similar features to the current part being evaluated. The model of the part may be sufficiently abstracted so that the evaluator 1104 only considers small portions of past images with features that match up closely to small areas of the present model for printing. The evaluator 1104 assigns scores to its observations, indicating similarity to the intent present in the inputs (e.g. the specified use case). The scores can be broken down into various categories such as dimensional tolerance, surface finish, quality given speed, etc. and the thresholds for these parameters can be informed by the intentions (e.g. the use case) provided to the predictor 1102. Failure to meet the established thresholds can trigger a response from the rest of the system. Profiles for prediction and evaluation can be constructed per material, as such variables represent the largest change in input settings and evaluation baseline.

The provided model for printing would also allow direct observation of the resulting part as it is being printed. The CMU 1100 can identify issues in real-time (such as discrepancies between an expected printing output relative to the actual printed output) and adjust the instructions being delivered to the printer in an attempt to remedy them. If the issues are deemed too great, the part may be determined a failure.

A detected failure could elicit an automated response from the system, including (1) pausing the printer and notifying the operator to make a final decision to its outcome; (2) automatically stopping the print, resetting the print bed and retrying the print with a different permutation of print settings; or (3) some other user specified response sequence. This could include real-time environment response, ensuring consistency between printers that may be situated in different conditions. A method for failure detection is described more fully below.

In some embodiments, the CMU 1100 is built from known observations. For instance, by installing cameras and other sensors on the printers, observations in the form of images or videos of parts being printed can be captured throughout the print process. User interactions with the parts can also be monitored. For example, if the printing process for a part is aborted, the process is most likely considered a failure. A photo captured at that point of the printing process can be tagged as such. In other cases, if the printing is not aborted, a part may be sliced with slightly different settings and the updated instructions sent to the printers. If the settings in the most recent iteration results in a suddenly large quantity of the part being ordered, it is likely indicative that this was a successful set of input settings for that part and material.

In some embodiments, users may be asked to manually review a print or run of prints to further provide data to inform the CMU 1100. There may be cases where the CMU 1100 incorrectly evaluates job outcomes, and having users manually override or correct these reports can address these errors. For robustness, the CMU 1100 may not be updated by an individual review, regardless if it is in agreement or disagreement with the print outcome. When an individual review is submitted, the CMU 1100 can search for a second similar instance elsewhere in the network providing the printing system 1000 (e.g. a different user's print farm, or a different user-instance 1020). This similar instance should specify the same or similar material, and similar print settings such as temperature. When that similar instance is reviewed manually, it can be compared against the initial manual review of the individual. If they agree, then the findings can be internalized to update the CMU's 1100 assumptions. If the reviews disagree, they can be weighted against one another by a credibility score. A user's credibility score can be determined by the user's number of prints, the success rate of previous reviews the user has made, and the average detected quality of their print outputs. Certain parameters in this credibility score may be calculated on a rolling basis.

For more robust information, a larger amount of similar material/settings outcome reviews may be required to inform the CMU 1100. A greater amount of these reviews for a particular material may have a greater influence on the model. The rationale is that if low quality prints are being produced often, and the model is marking them as “good”, the large wave of correcting reviews would quickly inform and update the model.

Manual reviews may be presented to the users by way of a user interface that includes a comments section to ask users to input information to indicate what went wrong. The input can be a picklist based on what items the model uses to evaluate quality (e.g. first layer, warping, rough surfaces, stringing, etc.). To incentivize manual review of job outcomes, users may be awarded free printing credits or some similar discount.

A feedback system can be implemented directly into the user control software. For example, when prints are aborted, users could elect to choose from a list of reasons. On successful prints, feedback can be requested as well. The reason and score selected by the user on the outcome of the print can be compared to the evaluations generated by the evaluator 1104 of the CMU 1100 and may be used to update the CMU model. In another embodiment, the CMU 1100 may be configured to notify users of potential issues. Dismissal of or action on those notifications could be used as feedback provided to the model.

The use of automated material profiles will now be described. To successfully print a part, the methods by which the printing material is deposited, and the environment in which the part is formed should be tuned and controlled with a degree of precision. As discussed previously, a 3D printing system is run by a file containing a long list of instructions that control various hardware and sensors of the printer. This file contains movement information, temperature set points, material feed rates, and other instructions that determine what the printer outputs. As noted above, such a file is normally generated by the slicer software, which translates a given 3D model representing the object for printing into low-level hardware instructions that the 3D printer can interpret. There may be hundreds of settings recognized by the slicer software that govern how instructions are generated from the given 3D model. The settings serve as rules by which the slicer will accommodate various geometries and features of a given part. These settings are almost entirely specified by the user. As different materials have different physical characteristics, each material requires its own group of settings, commonly referred to as “setting profiles” or simply ‘profiles’.

Based on the foregoing, a profile for a given material is intended to describe how it should be used on any 3D printer. However, the precise nature of additive manufacturing means that not only are the optimal settings affected by the configuration of the machine performing the printing task, minute hardware variabilities between identical machines, part geometries, age of the printing material, and environmental factors such as ambient temperature and humidity, can also affect what settings are needed to result in an optimally printed part. While standard profiles do exist, they generally serve as a suggested starting point and are often edited or “tweaked” to suit individual cases having regard to the aforementioned factors.

Optimization of material profiles often depends entirely on the expertise of the operator in charge of slicing the models. Decisions come from an intuition based on experimentation with various permutations of slice settings with various hardware, part geometries, material, and environmental circumstances. Further, the settings are additionally dependent on the desired physical properties of the part (e.g. strength, flexibility, visual appeal, weight, etc.), and optimizing for some properties may lead to the loss/detriment of others, so finding a suitable balance should also be considered. Additionally, optimization for different properties may be desirable at different positions within the same printed part itself. While operator experience informs a robust understanding, there are often too many settings parameters to be calculated and produced for any given situation. An operator's biases can also work themselves into the final output part.

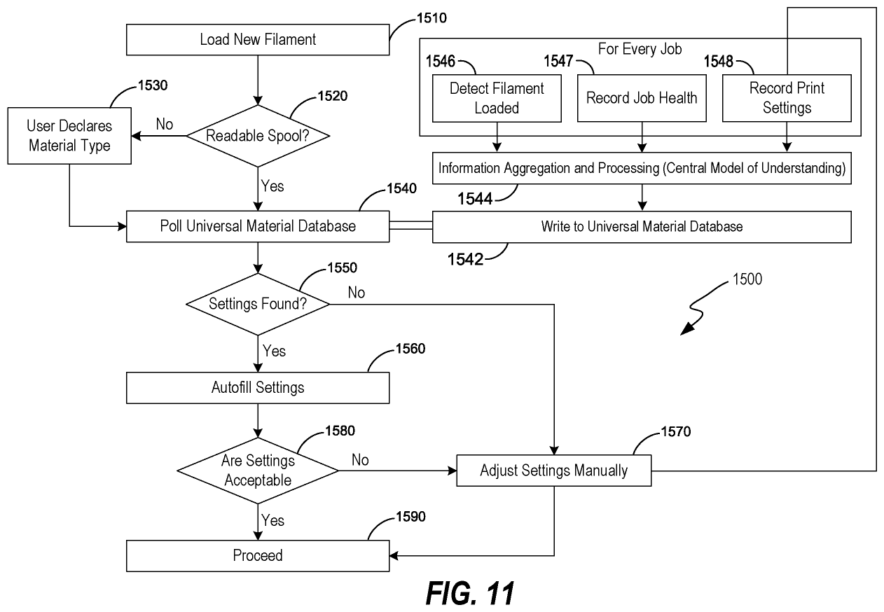

A method of automatic material profile settings generation is reflected in method 1500 of FIG. 11. At step 1510, a new printing filament spool is loaded, for instance, into a printer. The printer, at decision step 1520, may read data from the filament spool electronically. If the spool cannot be read electronically (e.g. following the “No” branch), the user is notified at step 1530 and asked to declare the filament material type. Subsequently, the universal material database 1110 of FIG. 10 is polled and material type is written to the database. If the spool can be successfully read (e.g. following the “Yes” branch of step 1520) then steps 1540 and 1542 are performed to store the acquired information with the universal material database 1110.

The universal material filament database may be used for onboarding of filament manufacturers or sharing print settings. Due to variability between batches of material, this database may also be used to store a manufacturer's batch ID or production runs (such as lot numbers). If the formula for a specific brand of filament changes, a new ID can be assigned and stored in the universal material database 1110 at step 1542.

In the present embodiment, data concerning the settings and temperatures used with each filament ID (whether manually loaded or not) could be collected from across the entire network of clients and printers to establish an average or baseline setting for the material. For example, the settings information can be aggregated at step 1544 by the CMU from filament data loaded at step 1546, job health data recorded at step 1547, and print settings recorded at step 1548 for every print job. The failure and success rates of prints assigned with certain setting ranges can also be considered. The objective is to populate a database of different material types with their average optimal settings. If a user/operator decides to begin using a new type of material in their farm, and the settings are found at step 1550 (e.g. following the “Yes” branch) the new print settings can be automatically populated at step 1560 with what worked for the multitude of other users who have already gone through the troubleshooting process for the same material. At that point, the user/operator can expect to have a set of workable settings that omits much of the coarse adjustment for the filament material and proceed to implement finer adjustments that might be specific to the 3D model being printed. Where the autofill settings are found to be acceptable at decision step 1580 (e.g. following the

“Yes” branch), then printing can proceed at step 1590. Otherwise (e.g. following the “No” branch), the settings are adjusted manually at step 1570 before proceeding to step 1590 to print. If the settings are not found at step 1550 (e.g. following the “No” branch of step 1550), then manual settings are adjusted/provided manually at step 1570 before printing can proceed at step 1590.

The foregoing automated material profile settings approach is feasible because the hardware is known and can be maintained to operate within set tolerances. The printers deployed on a given system can be designed or configured specifically for use with this system and are intended to remain indistinguishable from one another.

In some embodiments, a broader database of user-registered filament types may also be maintained. It can function on the same principles as described above (i.e. distributed setting iteration). However, rather than manufacturers submitting IDs, users can manually enter the filament name, type, colour, and other information.

The foregoing approach takes the current process of developing print setting profiles for each loaded material and distributes the process over a network of many printers that provides hundreds of hours of concurrent testing. This arrangement facilitates automatic and optimized setting selection.

To enable true end-to-end coverage, and to alleviate indirect labour that may arise as a result of the increased production capacity, the central print control and management service may run certain inventory tasks. For example, users can record the stock of filament using software provided via the service, and the software tracks the supply. A dashboard is displayed to show information about remaining stock, material currently in use, material with pending usage (items are queued up that use that material), and other statistics that will help users to use and allocate material more efficiently.

For standard spools of filament (i.e. spools without a chip containing a unique identifier), material inventory can be manually logged in software provided by the central print control and management service. The user inputs information such as material type, colour, date of purchase, weight, manufacturer, and a name. Inventory can be tracked through material usage in the printers by tracking filament weight and/or with filament detection sensors 203, as described above. Since estimates of filament weight are based on assumptions (e.g. spool having a standard initial weight), only spools that are depleted completely can be certainly detected in some embodiments. Filament out situations detected by sensors 203 can be recorded to track the decrease in inventory for that material.

“Smart” spools of filament incorporating a NFC chip or other passive memory device containing a material identification code can be more readily tracked, enabling integration between the system and filament manufacturers, and improving platform efficiency. The unique identification code is either assigned by the manufacturer or within the client's printing management instance (i.e. the particular manifestation of the software for the central print control and management service and its contents, accessible only to that client). As such, using the unique identification code, the user has the option of manually identifying material that may not have come with a code from the manufacturer. The user can also create custom material profiles that can be applied to jobs within a queue. Only a client's account (and any client-controlled sub-accounts) can access the version of the software that contains their data, including the client's specific configurations—printers, materials, submitted jobs, custom material profiles, settings, etc.

Users can log their filament supply in the inventory management portion of software provided through the central print control and management service. For smart spools, an NFC-enabled hardware device with an NFC reader may be used to scan the spools into the system, in addition to or instead of using a manual logging method. If a smart spool is recognized, the central print control and management service automatically populates information about the material and logs it.

If the filament roll is moved to another printer, it can still be identified through scanning of the NFC chip on the filament roll. The remaining amount of material for each roll (no matter how many printers it has been used on) can be tracked using the load cell method described previously. Even if no identification code has been assigned to the spool, the remaining weight can be stored to the passive memory device incorporated on the spool or tracked by the software system if the material is removed from the printer for storage. Thus, when put back to use, the central print control and management service can identify the precise amount of material remaining on the spool, rather than resorting to estimation.

As production schedules can be planned far in advance, there is a need to account for future use of inventory. In particular embodiments, items in the queue are considered by the central print control and management service when estimating inventory needs. If the weight of the queued items exceeds or comes close to depleting the current inventory for that material, a warning is generated to the user. An estimated date of depletion can also be derived from the items in the queue. Additionally, software executed through the central print control and management service can make recommendations for stock purchases, including quantity required (based on perceived need from what the queue requires to be fully executed as well as general usage patterns) and reallocation of print jobs.

In some embodiments, users can order more printing material through software provided by the central print control and management service. When an order has been submitted and processed, the status of the order can be tracked (e.g. whether the order has been shipped, or is in transit, or has arrived). The amount of material ordered can be directly logged as inventory at the time of purchase. Material arrival dates can also be used to inform the scheduler when ordering print jobs, as there is no point in queuing up a job during a time where its required material will have run out. Inventory levels can be used to determine the ordering of jobs within a given deadline.

Predictive ordering is a feature provided in certain embodiments, whereby 3D print farms automatically order the printing material required to complete their queue of jobs. As described elsewhere herein, estimated timing and filament usage can be used to determine the quantity of filament to order and when filament needs to be ordered.

In some embodiments the central print control and management service provides software that makes recommendations as to how many printers should be loaded with specific materials to optimally meet the demands of the queue. Such functionality is referred to herein as farm optimization through material allocation (FOTMA). A time savings estimation (e.g. “the next two weeks of jobs will complete 25% faster”) will be given to the user, allowing them to decide whether it would be worth the time to change the materials in the selected machines. The output of this optimization routine may be provided to an automatic filament changer system, eliminating the conventional need for labour trade-offs to be considered. The objective is to minimize the makespan of the queue. Because job scheduling of this type for greater than three machines is computationally complex (e.g. in terms of non-deterministic polynomial time hardness), machine learning or other algorithmic approximations can be employed to determine an optimal solution.

One exemplary method comprises dividing the total time of printing among all available printers for each material, then determining the allocation of printer such that each spool or cartridge of material is used up at roughly the same time. The overall queue can be comprised of sub-queues for every material type. It can be preferable to set up sub-queues for the purpose of job delegation, given that a print in X material will not be affected by how many Y jobs there are. While the order of jobs within these queues is determined by the scheduler, FOTMA is provided in a layer above this scheduling to manage the overarching interaction between the various queues and the 3D print farm. For printer allocation, FOTMA considers the total length of time required to complete each material's sub-queue and determines how to portion the total number of printers such that each sub-queue is fulfilled in roughly the same time. In most cases, this will result in an allocation proportional to the length of that material's sub-queue when compared to the total sum of all sub-queue print times. In some cases, however, this result is not desirable and FOTMA can recognize and ignore those instances (see Example 2 below). Other factors such as due dates and Multi-Job Orders (MJOs) can affect which printers are available to be allocated at certain times.

The examples set out below show how the central print control and management service can be applied to manage 3D print farms.

Example 1A: Suppose a 3D print farm of 40 printers contains 20 printers loaded with material X, and 20 printers loaded with material Y. The queue contains 100 jobs in material X, and 300 of the same jobs in material Y. Suppose that each job requires 1 hour. Therefore, the initial print configuration requires 5 hours to complete the material X jobs and 15 hours to complete the material jobs Y. However, the software determines that the quickest way to execute these jobs is using 10 material X printers and 30 material Y printers. Thus, after changing to the optimal configuration (i.e. 10 material X printers and 30 material Y printers) it would take 10 hours to complete the material X jobs and 10 hours to complete the material jobs Y, which would represent a 66% time savings over the initial configuration.

Example 1B: Suppose that a 3D print farm has the same initial configuration as for example 1A (i.e. 20 material X printers and 20 material Y printers). Suppose that the material X jobs have a deadline in 5 hours. In this case, the only way to complete the 100 material X jobs would be to keep the configuration of 20 printers reserved for material X.

Example 2: Suppose a 3D print farm of 10 printers has in the queue 3 material X jobs taking 100 hours for each job and ten material Y jobs taking 30 hours for each job. The sub-queues for each of the material X and Y jobs are both 300 hours, suggesting that 50% of the printers should be allocated for each type of material. However, this does not make sense, as allocating 5 printers to 3 jobs is not possible. Therefore, the software recognizes that these types of situations cannot be accommodated as they do not meet the constraints.

The print scheduler component of the central print control and management service factors in a number of variables to assign each job a score that ultimately determines its rank in the queue. Preferably, the job sequence is not locked in, so that as new jobs are input to the system, the queue can be rearranged for optimal execution within the parameters given by the users, such as material type, quality, colour, priority, due date or deadline, etc., as discussed elsewhere herein. The print scheduler decides in what order to complete jobs based on the constraints generated from these and other parameters. Some of the key considerations include, for example: can this part be batched with another job? Has this model been grouped in an MJO and is it required to be printed at a certain output group? What deadline did the user set and how does it compare to other jobs? What is the future printer availability?

Given the complicated structure of the queue, it can be more effective to allow the system (rather than individual users) to determine the delegation of print jobs. In particular embodiments, users however can be provided with one or more ways to affect the order in which jobs are executed. For example, certain users may be permitted to adjust the parameters of their job to indirectly manipulate its priority. As another example, certain users may be permitted to manually rearrange items in the queue through dragging and dropping.

Before a job is even submitted to the queue, the print scheduler will estimate the fastest possible production time. This is not necessarily immediate, as other jobs may have deadlines that constrict printer availability. The fastest production time is calculated from printer availability, material availability, and the estimated print times of preceding jobs in the queue. Not all preceding jobs will be factored as some may have lower priority, thereby allowing the new order to skip ahead. This calculation gives the soonest completion time assuming highest priority and sets a lower bound for the allowable due dates to be specified by the user.

To submit a print job (an individual print file to be executed by a 3D printer) to the master queue, a user prepares a print file. This can be done using “slicing” software. A print file contains a list of the commands (printer instructions) that the printer executes in quick succession. In general, a command is not executed until the one preceding it is complete. The commands in a print file are not linked other than being contained within the same file. A print file tells the printing machine how to move and provides the required print settings (e.g. temperatures, layer height, etc.) which can be used by the 3D printing system according to embodiments described herein. One example format for the print files is G-code. However, any suitable format may be used for the print files. Embodiments of the invention facilitate the queuing of print files and distribution of print files to an array of automated printers.

In a particular embodiment, the “slicing” software that converts 3D models to print instructions is integrated with the central print control and management service. Users can therefore submit their 3D models to the print queue, without first converting them to print instructions. In some embodiments, a 3D model is “sliced” into a print file only when it reaches the front of the queue. This allows the model's properties to be edited up to the point that they are printing. As well, this method enables the automatic arrangement of models (i.e. for print packing) and any changes that are made to the model properties do not require re-exporting the print commands through third-party software. Since models are stored and managed by the central print control and management service, repairs and edits can be made to the models themselves, which is not typically possible using G-code print files generated by third party software. The print files generated through the central print control and management service can be in any suitable format, including a proprietary format that the central print control and management service is capable of interpreting.

Upon upload of a print file to the queue, the user is prompted to enter the job parameters or specifications for the file. Parameters can include one or more of: due date, material type, colour, quantity, priority, nozzle type. If an invalid combination of parameters is chosen, the queue item will not be submitted and the user will be requested to change the settings or connect to a printer with appropriate materials.

The quantity is the number of times that a print job is to be repeated. While repeating a print job results in multiple prints, they can be treated as a single order. It is possible to refer to individual jobs within these orders. Orders that contain a quantity of two or more jobs or prints can be referred to as “quantity orders”.

The material and colour parameters assigned to print jobs can be used by the print scheduler to determine compatible printers. Orders can be rearranged in the queue to affect their priority. Since certain orders can only go to certain printers (e.g. same material/colour), it can be useful to be able to distinguish them from one another. For example, an order for black PLA may print before an order for white ABS despite the black PLA order being “lower” in the queue, if the black PLA printer becomes available sooner than one for ABS. Displaying the order should preferably avoid confusion of print jobs in a single master list. Solutions may include: providing separate queues for different colours/materials, sorting the master queue by materials, or including completion estimates next to each job, and automatically sorting the queue that way, with the priority being determined by a deadline setting.

Based on the order information received, the print scheduler determines what printer to assign the order to. For certain embodiments, complex modelling of printer availability and time estimation is not necessary as orders are assigned to compatible printers as soon as they become available. When a printer signals the completion of an order, the scheduler will notify a nexus 730 (as described below) where to delegate the next compatible order from the queue.

The nexus 730 (see FIG. 7) is a hardware device that resides with the client computing device 750 on the same network as the printers 720. It provides a central point of connection between a printer farm and the cloud, and facilitates printer status aggregation and local network management. A nexus 730 associates any printer 720 connected through it with the client's account. In certain embodiments, software pertaining to job delegation resides on the nexus 730 itself, reducing the cost for cloud services for performing the job delegation functions.

In certain embodiments, the print files for current and successive queue items for each printer 720 are stored on the printer controller module 710. This makes a small buffer available in case a connection is lost with the central print control and management service 740 on the cloud. As print jobs are completed, the next queue item and associated print file is pulled from the cloud.

Queue item metadata can be pulled from the queue and matched to compatible printers on the network. In particular embodiments, the scheduling method comprises matching the highest priority order with the compatible printer with the shortest remaining print time. Matches can be reported back to the cloud dashboard.

The nexus facilitates print command forwarding, which is functionally similar to transferring job files to the controller modules on each printer. Users are able to send lines of print commands though a console for the cloud-based central print control and management service and the nexus ensures the input is forwarded to the correct printer. The print commands can be input through a console with a text field for direct input, or a GUI for movement commands. Incoming print commands will contain a header that specifies the printer it is meant for, and the nexus will route it appropriately.

The nexus is responsible for collecting and organizing the printers' status into a series of files. These files can be maintained and updated by the nexus, and sent to the cloud-based central print control and management service when the appropriate requests are made. For example, on the general printer overview screen, connected printers, current job and print completion are displayed. Information is polled periodically, and most of it will be stored on the nexus and not on the cloud if it is unnecessary to do so.

Billing information is a set of information that can be constantly uploaded to the cloud. Billing information includes actual print times (described below) and the number and IDs of printers connected online, wrapped in the client information.

For diagnostics purposes, client data can be tracked, including total actual print time, actual print time per individual machine, number of items printed per week and number of aborted prints, downtime status calculated from the time that printers were intentionally suspended (due to the scalable nature of the system, printers that are taken offline could be a result of intentionally scaling back the usage), failure information (e.g. number of restarted or aborted prints per total number of prints, how far into the print it was before restarting/aborting, the temperature of the bed, and what material it was using).

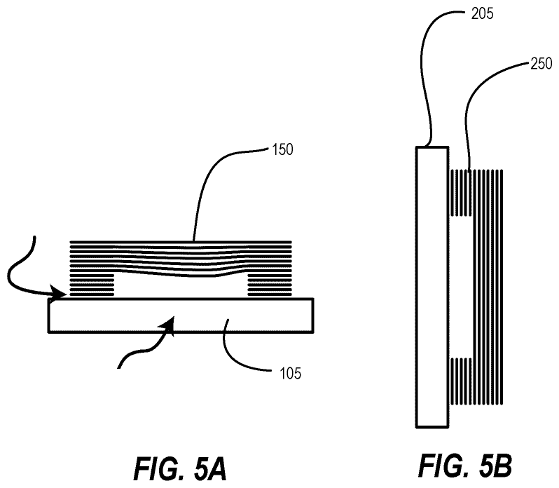

As mentioned above, the print bed need not be strictly vertical, and could be oriented at an angle to the vertical. While a vertical print platform is generally optimal for leveraging gravity for part removal, in other implementations a non-vertical print platform may be more effective. The geometry of the part may call for a certain orientation of the print bed for optimal print quality. For example, layers of a part may experience droop (due to the forces of gravity acting on those layers) in a horizontal print orientation in areas where there is nothing underneath to support those layers (see FIG. 5A); for such a situation, a vertical print orientation may provide better support for these layers thereby resulting in an improved print with no or less droop (see FIG. 5B).

In particular embodiments, the print bed does not need to move into a specific position to eject the part. The chassis of the printer can be designed so that parts can be ejected without interference. Alternately, for a print bed that moves only in the Z axis, another axis of movement can be added to the print bed (e.g. the Y axis) so that the bed is able to move along this additional axis until it clears the printer's frame.

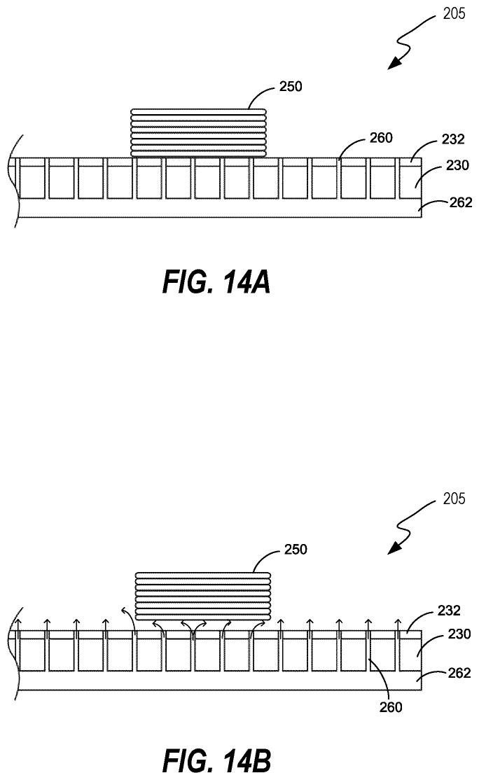

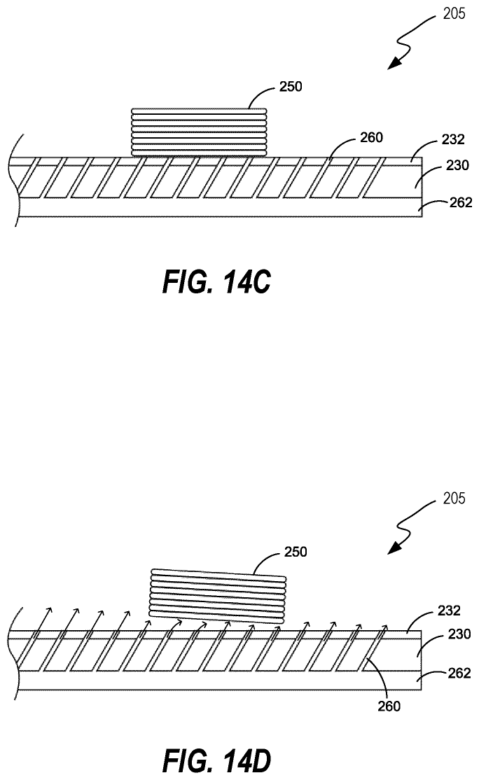

In particular embodiments, the print bed assembly 205 of FIGS. 2 and 3 may include small perforations distributed throughout its print surface 232. FIGS. 14A and 14B depict a cross-sectional view of such a print bed assembly 205. These perforations 260 traverse the platform 230 to allow air or another gas to flow therethrough. In some embodiments, the platform 230 may also operate as a heating element. A togglable gas source such as a pneumatic system (not shown) may be provided to supply the perforations 260 with the air or another gas via an airflow cavity 262 connected thereto. In one configuration, the gas source may be positioned behind the print surface 232 on the same side as the platform 230. Once a print job has completed, the flow of air or another gas can be activated. This flow of the air or another gas can be directed or forced through the perforations 260. The gas source and perforations 260 serve at least two purposes: (1) the movement of air or another gas can carry heat away from the print surface 232, substantially decreasing the period required for cooling; and (2) such movement provides a small force from the print surface that helps the deposited model 250 (i.e. the printed part) separate from the print surface once the adhesive force has dropped. In some cases, the air or another gas forced through the perforations 260 could be cooled in order to further assist with cooling down the print bed assembly 205.

In some embodiments, the perforations 260 are sized sufficiently small so that substantial amounts of deposited print material cannot be forced in and permanently obstruct the perforation(s) 260. Otherwise, the flow of air or another gas through the perforation(s) 260 would be blocked. The perforations 260 are also sized sufficiently small to avoid substantially limiting the contact area between the deposited model 250 and the print surface 232 to maintain enough adhesion of the deposited model 250 to the print bed assembly 205. Suitable sizes for the perforations 260 could range from 10 μm to 3 mm in diameter and 10 μm to 30 mm in length.

In some embodiments, once the deposited model 250 is detached, the air or another gas coming from the perforations 260 can form a cushion under the part as shown in FIG. 14B, similar to the surface of an air hockey table, allowing it to glide off the print surface. The directional arrows of FIG. 14B indicate the direction of air flow out of the perforations 260. This may be useful in printer configurations where the print bed assembly 205 is oriented at relatively shallow angles (with respect to a horizontal reference), as well as horizontally oriented print bed assemblies 205. However, the same perforations 260 can be used in conjunction with print bed assemblies 205 oriented at any desired angle. Minimal guidance, either from an angled bed, directed airflow, or some other apparatus may be used to move the deposited model 250 in a particular direction.

In some embodiments, as shown in FIGS. 14A and 14B, the perforations are oriented perpendicularly relative to the surface of the print bed so that the flow direction of the air or another gas is also perpendicular relative to the surface. However, in some other embodiments, the perforations may be oriented obliquely (i.e. at an angle other than perpendicularly) as shown in FIG. 14C relative to the surface. This configuration allows for the provision of a directed airflow as shown in FIG. 14D.

In yet other embodiments, the flow rate of the air or another gas may be spatially controlled. That is, the flow rate of air or another gas through a first perforation at a first position may be different from the associated flow rate with another perforation at another position. Further, perforations may be grouped together so the flow rate through each perforation of the same group is the same (the perforations belonging to the same group may or may not need to be adjacent to one another). Spatial control of gas flow may allow controlled activation of select perforations to obtain control of the movement of the printed model 50 to automate object handling.

In particular embodiments, the printer firmware can be configured to manage the automatic part removal process. Instead of using a central print control and management service, files can be delegated manually to each printer.

The printing material that is used for the embodiments described herein may be a thermoplastic, thermoplastic elastomer/rubber, or resin with a sufficiently low melting point. Such materials may include polyesters, copolyesters, polyolefin, ionomers, polyamides and the like. Some examples of 3D printing materials are polylactic acid (PLA) and its variants, acrylonitrile butadiene styrene (ABS) or polyethylene terephthalate (PET) and its variants, a thermoplastic elastomer (TPE) such as thermoplastic polyurethane (TPU) or thermoplastic copolyester (TPC), nylon, polyvinyl chloride (PVC) and its variants, polycarbonate (PC), polypropylene (PP), polyether ether ketone (PEEK), acrylonitrile styrene acrylate (ASA), polystyrene (PS), high-density polyethylene (HDPE), polycaprolactone (PCL), polyvinyl acetals such as polyvinyl butyral (PVB) or polyvinyl alcohol (PVA), polyetherimide (PEI), high impact polystyrene (HIPS), chlorinated polyethylene elastomer (CPE), polyphenylene oxide (PPO), polyphenylene ether (PPE), or a combination of these plastics. 3D printing materials may comprise a hybrid material comprising a base plastic (such as one or more of the above-listed plastics) mixed with another material, an additive, such as a wax, fibre (e.g. glass, carbon, poly paraphenylene terephthalamide, plastic) including continuous and shorter strands, metal (e.g. copper, bronze, brass, steel) flakes and powder, metal wire, wood dust and fibre, bamboo, stone, plant material (e.g. hemp, coffee, cork), clay, carbon (e.g. conductive filaments), ceramic, photoluminescent pigments, and the like.

Depending on its composition, the print surface and platform assembly can take some time to cool down after a print is complete. If faster temperature cycling is desired, a combination of heating and cooling devices can be used to facilitate automated part removal from the print bed and prepare the bed for the next print job. For example, heatsinks can be attached to the underside of the heater with fans that assist during cooling. Instead of, or in addition to using a resistive heater for the print bed (for example, to heat the print bed to facilitate adhesion to the printed material, a printed circuit board (PCB) with a single winding trace that provides resistance may be located between the print platform and the print surface or may be integrated with the print platform), Peltier tiles can be provided under the print bed and used to assist with faster temperature cycling. Peltier tiles are electronic devices that generate a temperature gradient between its surfaces when voltage is applied. One side gets hot and one side gets cold. During a print job, the tiles—sandwiched between the self-release surface and the print platform—would direct heat toward the print surface. When the print completes, voltage will be reversed, and subsequently the cool side of tile will be in contact with the print surface. An alternate configuration is to place the Peltier tiles on the underside of the platform itself, with the metal platform acting as a heat spreader. While they will not provide direct cooling to the surface in this configuration, leaving the bottom side of the tiles exposed would enable a heatsink to be mounted, therefore helping with overall temperature management. The Peltier tiles could also be used in conjunction with the resistive heater, where the Peltier tiles are activated only during cool down to help draw heat away. Heatsinks could also be added to the tiles to cool them even faster. Other methods of quickly cooling the bed include: a heat exchanger mounted on the underside of the heated bed through which coolant is cycled during the cooling phase, drawing the heat out of the bed and moving it to a set of radiators that dissipate it elsewhere.

In some embodiments, the operating temperature of the print bed during printing is between −20° C. to 275° C. In other embodiments, the operating temperature of the print bed is between 15° C. to 200° C. In still other embodiments, the operating temperature range of the print bed may comprise one of the following ranges: −20° C. to 275° C., −15° C. to 275° C., −10° C. to 275° C., −5° C. to 275° C., 0° C. to 275° C., 5° C. to 275° C., 10° C. to 275° C., 15° C. to 275° C., −20° C. to 265° C., −15° C. to 265° C., −10° C. to 265° C., −5° C. to 265° C., 0° C. to 265° C., 5° C. to 265° C., 10° C. to 265° C., 15° C. to 265° C., −20° C. to 250° C., −15° C. to 250° C., −10° C. to 250° C., −5° C. to 250° C., 0° C. to 250° C., 5° C. to 250° C., 10° C. to 250° C., 15° C. to 250° C., −20° C. to 230° C., −15° C. to 230° C., −10° C. to 230° C., −5° C. to 230° C., 0° C. to 230° C., 5° C. to 230° C., 10° C. to 230° C., 15° C. to 230° C., −20° C. to 225° C., −15° C. to 225° C., −10° C. to 225° C., −5° C. to 225° C., 0° C. to 225° C., 5° C. to 225° C., 10° C. to 225° C., 15° C. to 225° C., −20° C. to 218° C., −15° C. to 218° C., −10° C. to 218° C., −5° C. to 218° C., 0° C. to 218° C., 5° C. to 218° C., 10° C. to 218° C., 15° C. to 218° C., −20° C. to 212° C., −15° C. to 212° C., −10° C. to 212° C., −5° C. to 212° C., 0° C. to 212° C., 5° C. to 212° C., 10° C. to 212° C., 15° C. to 212° C., −20° C. to 207° C., −15° C. to 207° C., −10° C. to 207° C., −5° C. to 207° C., 0° C. to 207° C., 5° C. to 207° C., 10° C. to 207° C., 15° C. to 207° C., −20° C. to 200° C., −15° C. to 200° C., −10° C. to 200° C., −5° C. to 200° C., 0° C. to 200° C., 5° C. to 200° C., 10° C. to 200° C., and 15° C. to 200° C.

In embodiments described herein, the operating temperature for printing is within range of the glass transition temperature (T_{g}) of the printing material. There is a range of temperatures over which glass transition occurs for each particular material. Glass transition is characterized by the transition, as temperature increases, of an amorphous material from a hard and brittle glassy state into a viscous or rubbery state. The majority of materials that were tested for 3D printing using the apparatus as described herein have the best adhesion when the bed temperature is within range of the glass transition temperature of the printing material. However, in certain cases, the best operating temperature for printing deposited materials may lie outside their glass transition temperature. For example, some materials such as thermoplastic polyurethane (TPU) may adhere better on an unheated surface (i.e. at an operating temperature which is below the glass transition temperature). In such cases the operating temperature for printing may be at room temperature or within a certain range of room temperature. When the print bed is at this operating temperature, the resulting properties of the deposited material and the print bed result in maximum adhesion between them. Release of the deposited material is facilitated after the print by changing the temperature of the print bed. The large variance in surface energy that the print bed experiences over a certain temperature range, coupled with the deposited materials' change in properties over the same temperature range, disrupts the adhesive bond between the printed part and the print bed thereby breaking the bond and allowing for the automated removal of the printed part from the print bed. For embodiments where the operating temperature of the print bed is within the range of the glass transition temperature, changing the temperature of the print bed to facilitate release of the printed part is accomplished by lowering the temperature of the print bed to break the adhesive bond (since increasing the temperature above the glass transition temperature could result in melting and deforming the printed part). However, for those embodiments where the operating temperature of the print bed is below the range of the glass transition temperature, changing the temperature of the print bed to facilitate release of the printed part may include raising the temperature of the print bed to break the adhesive bond. Since the print bed is below the glass transition temperature, raising the temperature will not result in melting or severely deforming the printed part. In other embodiments where the operating temperature of the print bed is below the range of the glass transition temperature, changing the temperature of the print bed to facilitate release of the printed part may include lowering the temperature of the print bed to break the adhesive bond.

In particular embodiments, the rate of change in surface energy is directly related to the rate of change in temperature of the print bed. The surface energy of the print bed material is tied to its temperature. While there may be some lag between the change in temperature and the change in the material's surface energy, this lag is generally insignificant in addition to the time it takes for the temperature change to fully propagate through the print material and the part for the bond to be broken.

Some embodiments are configured so that the surface energy change sufficient to allow automated release occurs under 45 minutes for most print jobs. Particular embodiments are configured so that this surface energy change occurs under 10 to 15 minutes with no active cooling for an initial bed temperature of 60° C. when printing with PLA. Active cooling mechanisms, as described elsewhere herein, can be provided to accelerate cooling and decrease the time over which the surface energy change required for part removal occurs.

In some embodiments, the print bed is arranged horizontally or near horizontally. The bond between the print surface and the printed part will be broken when the appropriate temperature change is applied, however in this orientation, gravity does not provide a substantial enough assist to clear the part from the bed after the adhesive bond is broken. At a near-horizontal incline, gravity contributes more to the friction force than to removal. For a completely horizontal orientation, no component of the gravitational force vector contributes to the removal of the part from the build plate. In either situation, the bond between the part and bed is substantially broken by the temperature cycling, but there may still be frictional and electrostatic forces keeping the part in place. In such embodiments, external implements such as a dedicated sweeping arm, hot end assembly, an air blade/blower, vibration, moving the print surface back and forth rapidly, or some combination of the above, may be employed to remove the printed part from the bed. The external implement provides sufficient force to overcome friction, electrostatic, and/or other residual adhesive force between the printed part and the print surface. Once the part is dislodged from its initial position, it becomes significantly easier to move it across the print surface. Thus, there is an initial “break-away” force required, and a force to move the part around after that. Once any residual bonds are broken, the primary force in play is frictional.

Where the print bed is arranged vertically or near vertically, residual static electricity may in some cases prevent the part from coming off the bed after the bond with the print surface has been broken through temperature cycling. This static attraction can be disrupted as described elsewhere herein. However, any residual adhesive force between the print bed and the part after the temperature changes is generally low enough that the part (barring all other forces) does not stick to the surface and is removed by the effect of gravity. Once the print is dislodged from its initial position, it will be completely released due to the effect of gravity. Only a small displacement is needed to break any remaining bond that is present, as well as to sufficiently reduce the effect of any electrostatic forces present at the initial location of the part on the print surface.

The gravitational contribution to the removal of the part is described below. The removal force supplied by gravity in Newtons (N) is F_{g removal}=m*g*sin(θ): the force of gravity on the part multiplied by sine of the bed angle (as measured from the horizontal). Additionally, at diminishing angles (as the bed moves from a vertical toward a more horizontal orientation), gravity begins to contribute more to the frictional force on the part, which is given by F_{friction}=m*g*cos θ*μₛ: the normal force on the part multiplied by the static frictional coefficient of the surface material. Finally, there can also be some electrostatic force that needs to be overcome and is dependent on the contact surface area of the part.

F_{g removal} needs to be greater than F_{friction}+F_{static}. To maximise the force of removal and minimise the force of friction, a 90° incline (vertical orientation) can be selected for the build plate (print bed). However, in cases where this is not possible (and even in cases of a vertical or near vertical build plate where the electrostatic force is very high), additional force may be required to supplement F_{g removal}. This can be provided through the supplementary removal methods as described elsewhere herein.

In particular embodiments with the print bed in a vertical position, gravity contributes between 5% to 100% of the force required to remove the part. The contribution of gravity roughly follows sin(θ) (sin of the bed angle with respect to the horizontal up to and including 90°). So, the percentage at any given angle will be given by whatever initial percentage is selected from that range of 5-100% multiplied by sin(θ) (e.g. 5% sin(θ), 10% sin(θ), 15% sin(θ), 20% sin(θ), 25% sin(θ), 30% sin(θ), 35% sin(θ), 40% sin(θ), 45% sin(θ), 50% sin(θ), 55% sin(θ), % sin(θ), 0% sin(θ), % sin(θ), 5% sin(θ), 70% sin(θ), 75% sin(θ), 80% sin(θ), 85% sin(θ), 90% sin(θ), 95% sin(θ), 100% sin(θ)). If the bed is inverted (tilted greater than 90°), the contribution of gravity makes up 5% to 100% of the force required to remove the part (e.g. 5%, 10%, 15%, 20%, 25%, 30%, 35%, 40%, 45%, 50%, 55%, 60%, 65%, 70%, 75%, 80%, 85%, 90%, 95%, 100%,).

However, where the incline of the print bed is horizontal or near horizontal, gravity will contribute an insufficient amount for removal, such that external implements are required for removing the parts once the bond between the print surface and the printed part is broken through temperature change of the print bed. However, since the adhesive bond has been already broken through temperature change of the print bed, these implements do not need to scrape the printed surface or apply such force so as to cause damage to the print surface.

Where certain materials may not exhibit enough adhesive force for printing when deposited on the print surface, a sacrificial interface comprising a suitably behaving material may be printed below the primary object. Deployment of such an interface can also apply in the case where the model's material exhibits an excessive adhesive force. The interface material can be chosen to provide good adhesion for the deposited material yet behave correctly with the variably adhesive properties of the print surface. The interface can be removed in a post processing step within the 3D printing workflow. This may include the part and interface being released into a solvent bath that affects only the interface (e.g. disintegrates the interface but not the printed model), or other common post processing techniques.

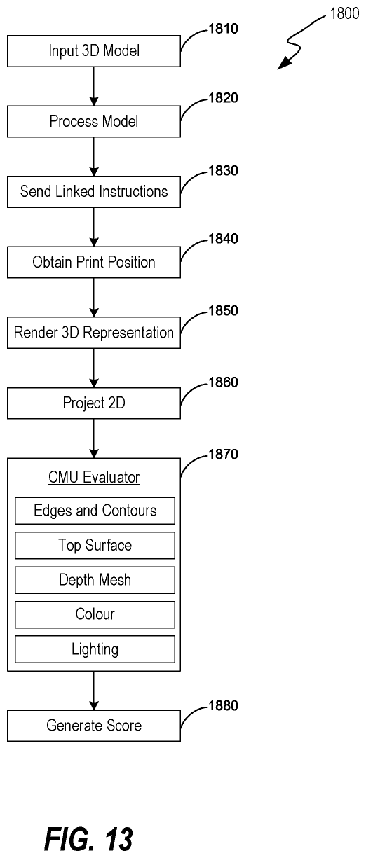

In respect of quality control and print process monitoring, it is generally desirable to identify situations where the part being printed is unlikely to meet the desired quality standards early on, as such instances would be considered a print failure. Accordingly, automated failure detection processes such as process 1800 of FIG. 13 may be implemented by the disclosed printing system to identify print failures as described more fully below.

The print failure detection process 1800 is a quality evaluation mechanism that can be implemented as an automated system to ensure that print jobs proceed correctly. The process 1800 described herein may enable constant print monitoring to identify print failures or print malformities based on evaluations in accordance with user specified tolerances and automatically react in a prescribed fashion relating to the type of detected fault.

In some embodiments, print monitoring can be carried out in accordance with a check interval. This interval defines the period, given in Z height, layers, or time, in which all the conditions given to the evaluator 1104 should be checked. This interval can also be defined in respect of multiple layers (e.g. perform a check after a set number of layers have been printed) or multiple times per layer. Different conditions may also be checked at different intervals. Certain special conditions may be defined, where a check is carried out once during a print. For example, certain one-time checks may be carried out in respect of the first layer, but are not performed with respect to subsequently printed layers.

The process 1800 is not restricted to FFF 3D printing, and can be applied to other forms of printing. Most of the components/considerations outlined below can be applied to FFF 3D printing in general, and even to other types of 3D printing (including Bound Metal Deposition (BMD), PolyJet™, or any type of 3D printing where the constructed model is not occluded from view). In some embodiments, implementation of the process 1800 allows automatic removal of faulty parts and automatic reprinting of replacements.

The error detection process 1800 can be generalized as a method comprising creation of a virtual model of each ongoing print (e.g. a virtual model of a partially printed part), which is built up synchronously from the actual 3D model and print information for that part. From this virtual model, the system determines an expectation of what the cameras/sensors installed at the printer should be observing. This expectation is compared by the evaluator 1104 to what the cameras/sensors actually observe.

The expectation is a model generated by the failure detection process 1800 that provides a reference against which real measured/observed data is compared. The expectation model can be generated from user submitted files, such as a G-code file representing the 3D model. Submission and processing of G-code files or 3D model files can be performed at steps 1810 and 1820. The G-code can be communicated to the printer at step 1830 as they are linked instructions for the printer.

Where a G-code file is submitted, the contents of the file comprises a collection of points in space and positions between any two points are interpolated by the printer. The G-code file also includes information about speed, acceleration, and whether to extrude the print material at the various points. By parsing the G-code file, the various print positions of the printers during a print session can be determined. Data concerning actual printer positions can be received from the printer at step 1840. Accordingly, it is possible to virtually simulate the desired motion of the printer and construct a virtual 3D representation of the printed output at step 1850. This reconstruction represents an ideal output and is what the actual print would be compared against. A 2D projection is generated at step 1860 to determine a representation of the printed part corresponding to what a printer sensor such as a camera positioned at the printer would observe at a particular stage of the printing process. Visual, depth, infrared sensors and other suitable sensors could be used to track the print progress.

Subsequently, the 2D projection is evaluated at step 1870 by the evaluator 1104 of the CMU 1100 of FIG. 10 for which a score is outputted at step 1880. The evaluation procedure is described more fully below.

In some embodiments, the expectation model can be generated as follows: the printer begins reading from the G-code file (e.g. sent to the printer at step 1830) for the current job. A duplicate copy of the G-code file may also be maintained by a print failure detection (PFD) instance for the printer. The PFD may be deployed in the cloud server 1010 or the printer, or partially in the cloud server 1010 and partially on the printer. As the print job proceeds, the printer may be in constant communication with the cloud server 1010. The information transmitted to the cloud server 1010 contains the current file position, a value that indicates the current job progress. A portion of the file up to the current position is reconstructed and rendered by the PFD in 3D space at step 1850. The resulting 3D model is projected onto a 2D view at step 1860 that is based on the known position and focal length of an actual sensor (e.g. camera) on the printer or depth. This projection constitutes a representation of what the sensor should be detecting.

In some embodiments, a 3D model file (.stl, .obj, etc.) corresponding to a model of the part is submitted at step 1810 rather than a G-code file. Any 3D files submitted by the user can be converted to G-code for processing, for example at step 1820, as G-code can be communicated directly to the printer at step 1830 as linked instructions. In some embodiments, the deployed 3D printers may use a different protocol for communication, and as such, a means of generating the expectation model from non-G-code files can be provided. Similar to the above, print positions are obtained at step 1840, and a 3D representation and 2D projection are generated at steps 1850 and 1860, respectively.

In some embodiments, when a user submits 3D models (.stl, .obj, etc.), it will be converted to print instructions rather than G-code. These print instructions can be rendered virtually as they are executed by the printer in the same way as G-code is executed in the example above.

By generating the expectation model from the print instruction directly, the fault detection system can see the same as what the printer sees: (1) any additional structures generated in the slicing step such as supporting structures would be taken into account and included in the print instructions; (2) the position of the printer's print head at all times would also be known and can be taken into account; (3) the location of the model in relation to the print surface and, in some cases, in relation with other models placed into the same job; and (4) any changes to the model after the print has begun would also be visible.

In some embodiments, generating the expectation model directly from the submitted 3D model during an ongoing print is also possible. The 3D model can also be sliced according to the same settings used for the submitted job. The approach of using the 3D model, however, provides a useful way to check dimensional tolerance as well as detail, as these are often lost in the slicing step when G-code (i.e. print instructions) are generated. In some cases, the 3D model analysis can be used as a supplemental analysis. The printer can be generally configured to always print from a set of print instructions. Print instructions sent to a queue can be associated with the 3D model from which they were generated. Unlike in the context of rendering print instructions directly, it may not be possible to build up the expectation model by looking at what position of the print instruction file the printer is currently reading. The 3D model file contains only the entire, complete model. To simulate ‘building up’ the 3D model representation, the printer's Z position can be polled while printing (e.g. at step 1840 to obtain the print position), and the resultant 3D model would be clipped/discarded at every point above that Z height. This way, only the parts of the 3D model that are below the printer's current Z height will be considered in the expectation model, as anything above that Z height would not have been printed yet. Additionally, when the print instructions are generated, where the print was placed in relation to the print surface should be noted. The 3D model itself would also not contain information about orientation relative to the printer, so it may be useful to record this information from the acquired sensor data, especially in the case where prints may be automatically arranged on the print surface.

A discussion of various rendering approaches to generate useful baselines (e.g. the 3D representation and corresponding 2D projection that make up the expectation model) for comparison with the actual printed part is presented herein.

A full rendering of the 3D representation can be carried out so that the complete print instructions are rendered in 3D space to construct the expectation model. For actual model comparison, any non-printing moves (e.g. whenever printing material is not extruded) can be disregarded.

Additionally, should the printing system be installed in known printing hardware, a model of the hotend assembly and the gantry on which it rests can be created. The position of these assemblies can be given by the print instructions and in this case the non-printing moves are considered.

To generate the 2D projection, the positions of sensors are established in the virtual 3D space to correspond with their actual positions in the physical printer assembly. The sensor hardware is generally known ahead of time. In the case of cameras being deployed as sensors, their focal lengths can be also be simulated. A 2D projection can be rendered from the point of view of these sensors and used for comparison.

In some embodiments, the printer may employ specific lighting systems that may affect the colour and luminosity in certain portions of the print. These systems may be considered in the expectation model. Obvious edges can be produced from the lighting system, characterized by stark changes in surface angle or by sudden changes in surface lighting.

Machine vision systems are generally proficient at detecting edges. These qualities are useful for comparisons in the context of fault detection as edges are relevant to many of the models that are printed. All the model edges can be generated from the complete print instructions beforehand, and any edges above the highest print move (e.g. the current Z height) can be disregarded. While all edges are generated beforehand, only those that would have been created up to the current point in the print instructions may be considered.

In addition to edges, the outline or outside contours of the model described in the print instructions can also be taken into account. This aspect may be the simplest check in the context of comparing the contours of the rendered model and the actual contours of the printed part at a given time point to ensure printing is advancing nominally (i.e. no discrepancies that may suggest a printing fault).

Depth mesh analysis is similar to visual analysis except rather than rendering an image expectation, a map of distances between the model and the sensor is generated. These simulated distances are compared to the actual readings of the depth sensor.

Top surface analysis is an analysis of the model from the edge-on perspective. It examines the latest printed layer and detects warping or other deviations of this layer. The top layer is normally expected to be horizontal (e.g. relative to the print surface), although certain features may cause it to sag (such as when spanning unsupported gaps) or warp upwards (in the case of thermal contraction). Peeling can be checked by looking directly using top surface analysis from the edge of the printed part against the expectation model. It may be possible to see whether the first layer of a print is peeling up due to lack of adhesion or improper leveling. Similarly, the print/deposition of new subsequent layers against the expectation model can be inspected. A threshold can be defined in respect of deviations from a “perfect” horizontal (or whatever is the motion extruding the material) and can be noted and scored by the evaluator 1104.

The foregoing rendering approaches can be used to generate the expectation model that changes in sync with the actions of the printer and provides a reference for every point in the print process.

The part being printed is evaluated at step 1870 of FIG. 13 against the expectation model. In some embodiments the evaluation can focus on one or more of the following relevant features: top layer, edges, and depth. The inspection can be performed automatically by the CMU evaluator 1104 as described above to generate a score at step 1880 to its observations, indicating similarity between the expectation model and the printed part. Also noted above, the score can be broken down into various categories such as dimensional tolerance, surface finish, quality given speed, etc. Failure to meet the established score thresholds can trigger a response. Prior to evaluation, adjustments to the evaluation model can also be made as discussed below.

Sometimes, the model file might be offset in the x- or y-axis depending on what machine settings are used. If the render viewpoint remains fixed, it would not be possible to generate an accurate virtual 3D representation as the virtual representation would not line up with the physical representation. Accordingly, such an offset should be accounted for prior to conducting the evaluation.

Z height tracking can be accomplished using horizontally facing sensors as the model is built to get a suitable edge-on view of the newest layer. Any curling or vertical warping in the top layers can be identified with this method. The baseline may have to account for the perspective shift prior to evaluation.

Machine motion can be simulated and taken into account. Since the print system is operable to process G-code, a virtual representation of the printer can be simulated and factored into the evaluation. This approach may be carried out on two aspects: first, if the expected machine position is known, any artefacts that may be caused by the machine blocking certain views of the model from the sensor would be known and can be ignored. Second, it would be possible to detect whether the machine itself was not in the intended position, though this may be rendered redundant through the use of other monitoring hardware such as motor encoders.

Camera position must be known in order to be able to generate an accurate comparison baseline rendering.

In some embodiments, lighting, if not accounted for, may introduce shadows that can obscure certain features. A consistent lighting system, or at least one that is controllable, may be necessary.

In some embodiments, a baseline image can be taken, corresponding to an image of the printer before the print starts.

Exemplary inspection methods to evaluate the expectation model with the printed part are now presented. The described methods are not intended to be exhaustive and other suitable methods can be used for evaluation. The methods are described from highest to lowest in terms of computational demand. As such, they are also ordered from most accurate to least accurate. While a single method can be used at a given time, it may also be possible to use a combination of two or more methods for evaluation.

A visual inspection can be performed by simulating what the expected outcome is and making visual observations of quality, colour, surface consistency, layer alignment, etc.

All the regular/static parts of the printer can be masked. As most parts of the printer will remain constant/stationary relative to the camera, the baseline model may be rendered to only consider new information in its evaluation of the part, and all background areas can be ignored.

A depth analysis can be carried out to check whether a given distance from the sensor to the printed part matches with the expectation.

An evaluate edges step can be performed to check whether the perimeter of the observed part matches the expectation model.

An inspection can be carried out as to whether larger parts of the model fail or if the model prematurely detaches from the print surface. Similarly, inspection can determine if a support structure has broken by comparing against the expectation model.

The print bed is checked to ensure that it is fully clear. If parts are still stuck, a suitable removal apparatus can be moved to the location in question to remove the part.

The foregoing inspections can be carried out as a print job is being performed. Printing actions can be repeated until a threshold is reached, indicating the likelihood of failure. If printing continues to “fail”, the user can be notified.

In some embodiments, a model may be too small to be observable or certain parts are obscured by the print head. If the PFD instance determines it is lacking enough information to assess the integrity of the printed part, it may call a peek routine to visualize the obscured portion. When a peek routine is called, the print job is paused and the hotend moves away to reveal the structure(s) obscured by the hotend. Once the PFD is finished assessing the structure(s), the hotend returns to its former position and the print job can resume. The printer can roughly ascertain where to move the hotend by referencing the expectation model which reflects the structure of the printed part. In most cases, the printer is able to determine roughly what the hotend assembly looks like, so a peek handler knows how far to move the hotend to reveal the obstructed portions of the print.

In some embodiments, the hotend can simply be moved to an extreme part of the print bed, without referencing the expectation model, to ensure that it does not obstruct the sensors. In some circumstances, the print bed may be filled with multiple printed parts or a single part so large that it is impossible to move the hotend to a spot where the part(s) are completely uncovered. In this situation, the PFD can break its assessment into multiple asynchronous blocks. In this manner, even if one part is currently obscured by the hotend, the other parts can still be evaluated. This approach may be useful as the hotend already moves around the print bed to print large layers, so eventually most portions of the printed part would be observable because of this movement.

In some embodiments, a peek routine can be triggered whenever a complete image of the printed part cannot be obtained within a check interval. For example, it may be desirable that one complete image of the top surface be obtained during every check interval. If the surface is not completely imaged within the interval, meaning that there are portions of the print surface that are constantly obscured by the hotend assembly, then a peek can be initiated.

In some embodiments, the peek camera can also be a part of the hotend assembly, and the hotend could move to a vantage point at every check interval to observe the top layer of the printed part.

If an issue is identified with the printed part, an automated response may be triggered. The printer may also make an attempt to repair an affected/faulty area question by injecting extraneous instructions in the typical flow of G-code. For example, an unexpected hole in the printed part may be identified by the vision system. The size of the hole may be evaluated, and additional motion is added to the stream of incoming G-code that guides the print head to fill up the identified hole.

In certain embodiments, print quality control may be monitored on the basis of motor performance or motor current draw. For example, methods of detecting process anomalies in motion systems includes measuring power consumption, voltage, and current. A baseline profile can be built per motor, and deviations from the baseline can indicate some sort of irregularity in the motion. This technique can be used to measure pump motor performance and can be used to signal maintenance or jams. Such methods can be combined with the use of encoders to detect whether the motor is out of position.

Motor performance may be used to detect issues with material extrusion. The extruder motor must maintain a certain amount of pressure on the feedstock in order to ensure correct material flow. Aberrations in motor performance could result in print defects. Conversely, print defects can be detected by these values against an expected load.

Expected motor power draw can be modelled by taking voltage and current measurements and correlating them to the type of motion being performed by the motor. 3D printers have motors for motion, and motors for material extrusion. The load on motion motors is primarily influenced by the printer's construction and movement instructions. Extrusion motor load depends on the extruder hardware configuration, extrusion speeds, temperature of hotend, solid material friction, molten material flowrate, feedstock material properties, hotend design, and environmental factors.

Measured voltage and current values can be recorded throughout a print and the feedback incorporated into the CMU. For extrusion, different materials and settings will result in different motor load profiles. Certain types of failure will not only cause deviation from the baseline but distinct deviations from the expected load. For example, a partial clog may manifest as the extruder drawing much more power than expected to push filament. In the case of the extruder, power draw correlates to pressure in the feedstock. Change in pressure can be used to determine flowrate. Unexpected changes in pressure indicate a potential problem. The nature of the unexpected change can be mapped to specific defect or failure modes through correlation with other model observations (e.g. visual, or user feedback) in the CMU.

Monitoring pressure can also be used to unobtrusively measure and correct issues with filament deposition. In the case of the first layer of a print, it is imperative to have a consistent thickness of material applied across the build surface: if the nozzle is too far, the molten material will not have sufficient contact with the surface and adhesion will fail. If the nozzle is too close, the material may get jammed up in the hotend, or the extruder might start grinding away the filament and lose traction altogether. Variation in the thickness of the first layer can be caused by an uneven bed, and most ways to combat this use some sort of external probe to pre-emptively map the surface of the bed and make height adjustments during printing. The probe often does not accurately reflect the actual state of the hotend, cannot account for temperature shifts, or warping in the print bed shape that can occur after a probe or during a print.

By actively monitoring the load on the extruder motor, it is possible to make height adjustments during the first layer based on deviations from the expected load. If the nozzle is too low, pushing material out will be much more difficult and cause excess current draw by the extruder. If this is recognized by the CMU, instructions to raise the nozzle can be injected into the stream of print instructions to lower the pressure. At this point there will have been some backpressure created from the nozzle being too low, so the flowrate could also temporarily be decreased until it returns to normal. Conversely, if the extruder load is much lower than expected, the nozzle can be lowered. This results in a system that adjusts to uneven conditions in real time.

The same system could be applied in later parts of the print as well, as the entire model may in some cases warp slightly over the course of a print. By adjusting pressure, nozzle height, and flowrate, dimensional accuracy will be preserved. It also provides the additional benefit of mitigating any runaway failures that are the result of small extrusion errors that slowly accumulate over the course of a model.

The foregoing measurements can be combined with all other observations to further inform the CMU and develop a real-time automated response to changing conditions.

In some embodiments, the fault detection methods described herein can be incorporated into a process that provides automated print process monitoring with live/real-time print settings changes as shown in process 1600 of FIGS. 12A and 12B.

Referring first to FIG. 12A, the process begins at step 1602 where a 3D model object is submitted for 3D printing. Upon receiving the object for printing, optimal print settings are predicted at step 1604. The prediction methodology can be automated and carried out by the CMU 1100 of FIG. 10, as described above in connection with method 1500 of FIG. 11. As noted above, the predicted settings can be derived from user preferences at step 1606 and aggregated printer configuration data from the print farm at step 1608.

The predicted print settings are presented to the user at step 1610 as suggestions. At this point, the user may choose to make additional manual adjustments at 1612. These adjustments are saved at step 1614 to the CMU database such as the universal material database 1110 of FIG. 10. In some cases, these adjustments are not committed to the universal material database 1110 until their success is evaluated by the evaluator 1104 and feedback has been collected, as described previously. The adjustments can be tracked to inform such an evaluation step later. This is to prevent users committing erroneous or low-quality settings directly to the model. This approach does not prevent user-defined profiles from being generated from their edits and adjustments, but such user edits may not directly (or automatically) end up in the CMU 1100 or the universal material database 1110. Where no user adjustments are made (i.e. the user is satisfied with the settings), the suggest settings of step 1610 can be used for further processing at step 1616, which includes providing the settings to the slicing software to convert the model and associated print settings to print instructions such as G-code.

At step 1618, an expectation model is generated from the processed model data from step 1616 for the purposes of evaluation and failure detection. Concurrently, or sequentially, the processed model data from step 1616 can be dispatched to the printer at step 1620 to commence printing of the part defined in the model. As printing proceeds, the printing progress is monitored at step 1622. Feedback data such as modified settings established during the print process may be provided, as described more fully below.

At step 1624, the fault detection may be performed by the evaluator 1104 of the CMU 1100. The expectation model obtained from the original model and user preferences at steps 1626 and 1628, respectively, are compared against data representative of the actual printed part at step 1630. A success score may be generated at step 1632 reflective of this comparison.

Continuing now to FIG. 12B, at decision step 1638, the score is assessed to determine if it is below a threshold value. If the score is above the threshold value, the process moves along the “No” branch to step 1652 to determine whether printing has completed. If the score is below the threshold (e.g. one or more mismatches exist and/or the printed part is outside of set tolerances), the “Yes” branch is followed to step 1640 and the CMU 1100 may be invoked to evaluate the cause.

At step decision 1642, the predictor 1102 of the CMU 1100 is invoked to determine a new permutation of print settings in view of the determined cause that would likely increase the score above the threshold (e.g. to produce a successful outcome). If the no permutation is available, then the process proceeds along the “No” branch to step 1644 where a failure mode is invoked to notify the user of a print failure. In some embodiments, upon detecting an error, the print job may be terminated and the partially printed part could be removed from the print bed so that the part can be reprinted under different print settings. In other embodiments the print job may terminate upon notification to the user.

If a new permutation is available that would likely increase the score and lead to a successful outcome, the “Yes” branch is followed to proceed step 1646 where the predictor 1102 applies the new print settings to the print job by dispatching modified print instructions incorporating the new print settings to the printer at step 1650. Additionally, the predictor 1102 may record this changed setting at 1648 as reference data for future evaluations.

At step 1652, whether the print job is complete is evaluated. If the print job is not complete, the process moves along the “No” branch back to step 1622 of FIG. 12A to continue monitoring the print job. This feedback loop permits continued process monitoring by further evaluating the printed part for mismatches and adjusting print settings in real-time as necessary in accordance to steps 1624-1650 as described above.

If it is determined that the print job has completed, the process moves along the “Yes” branch where the evaluator 1104 is invoked at step 1654 to generate a score for the final print and identify any defects using the techniques described above. Concurrently or sequentially, a user interface (UI) and the CMU 1100 may be used to solicit feedback from the user at step 1656. The user's feedback, as described previously, can be compared to the evaluations generated by the evaluator 1104 of the CMU 1100 at step 1658 and may be used to update the internal model that defines the CMU at step 1660.

The methods and systems described herein enable scaling of 3D printing to larger print volumes through automation of part removal and automated operation and control of a large, dense bank of networked 3D printers. Scaling of 3D printing enables more economical in-house manufacturing, which can revamp supply chains and make product delivery faster and cheaper. Additionally, due to the universal nature of 3D printers, manufacturing single parts becomes only marginally more expensive at higher volumes. This opens up a market for highly customized, but inexpensive products. It also provides a scalable solution where products can be made-to-order rather than estimating demand or running a pre-sale. A fully automated process also enables lights-out manufacturing, expanding the output of a print farm by enabling it to work overnight or on weekends without direct supervision.

Printers that were not intended for automation can be retrofitted with the solutions for automated part removal that are described above in accordance with embodiments of the invention, making use of the existing print functions and therefore avoiding significant redesign such as those required by other part removal solutions. In a particular embodiment described above, automated part removal is achieved by providing a Mendel style printer (where the nozzle moves along X and Z axes, print bed moves along the Y axis), rotating the printer 90° from its standard horizontal orientation, and attaching the self-releasing print surface and other attachments to the printer frame to ensure it can run on its side. The print surface can be attached to the print bed using a heat-resistant adhesive, clips, magnets embedded on the underside of the surface and/or in the print platform, and other suitable means. Cycling the temperature of the print surface changes the adhesive properties of the print surface to enable adhesion of the part to the print bed during printing and release of the part from the print bed upon completion of the print.

With an automated part removal system, it will no longer be necessary to provide a technician with constant access to the machines for part removal. As a result, printers can also be arranged in a significantly denser formation, utilizing factory floor space more efficiently. This is particularly so where the automated part removal system is contained within the envelope of the printer. Printers would need only enough clearance for the parts they eject to fall through the chassis, as well as a means of transporting parts to a more accessible location.

As the print surface substrate does not rely on a thin surface coating to function, it can continue to function even when damaged. Moreover, the part removal process requires little force, so that damage to the surface is uncommon. The system requires no consumables (such as tape, removable surfaces, cleaning agents) to function.

By contrast with other parts removal systems which require additional moving parts (that may wear out, jam, and break down), the automated part removal system described herein does not require additional moving parts, as it leverages existing mechanisms on the printer. Therefore, reliability is predominantly determined by the printer that the parts removal system is installed in, and not the automated part removal system itself.

Unlike other systems which make use of print surfaces that are generally material-specific (i.e. the bed must be replaced or retreated whenever the print materials are swapped), the print surface material in the embodiments of the invention described above works with most commonly used printing materials. This improves efficiency, since print beds do not need to be replaced or re-treated whenever materials are swapped, and avoids the need for maintaining different types of beds and surface coatings in inventory.

The examples and corresponding diagrams used herein are for illustrative purposes only. Different configurations and terminology can be used without departing from the principles expressed herein.

Although the invention has been described with reference to certain specific embodiments, various modifications thereof will be apparent to those skilled in the art without departing from the scope of the invention. The scope of the claims should not be limited by the illustrative embodiments set forth in the examples, but should be given the broadest interpretation consistent with the description as a whole.

1. A print surface applied to a print bed to facilitate release of a part printed by a 3D printer from the print bed, wherein the print surface comprises a material which bonds to the deposited printing material when heated, and once cooled, loses its bond to the deposited printing material due at least in part to a change in surface energy.

2. The print surface according to claim 1 wherein the material bonds to the deposited printing material when the print surface is heated to an operating temperature, wherein the operating temperature is in the range of −20° C. and 275° C.

3. The print surface according to claim 1, wherein the material bonds to the deposited printing material when the print surface is heated to an operating temperature within a certain range of the glass transition temperature of the deposited printing material.

4. The print surface according to claim 1, wherein the print bed is oriented vertically, substantially vertically, or at an incline to the horizontal, and as the print surface is cooled from the operating temperature the surface energy decreases sufficiently such that gravity supplies at least 80% of the energy needed to overcome the mechanisms adhering the part to the print bed.

5. The print surface according to claim 4 wherein a decrease in temperature of the print surface in the range of 5° C. to 20° C. from the operating temperature results in a sufficient decrease of the surface energy such that gravity supplies at least 80% of the energy needed to overcome the mechanisms adhering the part to the print bed.

6. The print surface according to claim 1, wherein the material comprises a glass-reinforced epoxy laminate material.

7. A method of facilitating automated removal of a printed part from a print bed of a 3D printer, comprising:
applying to the print bed a print surface to facilitate release of the printed part from the print bed, wherein the print surface comprises a material which bonds to the deposited printing material when heated, and once cooled, loses its bond to the deposited printing material, or a print surface to the print bed according to claim 1; and
cycling the temperature of the print surface to change the properties of the print surface to enable adhesion of the part to the print bed during printing and release of the part from the print bed upon completion of the print.

8. The method according to claim 7 comprising orienting the print bed vertically or substantially vertically to enable gravity to pull the printed part away from the print bed upon completion of the print.

9. The method according to claim 7 comprising orienting the print bed at an incline to the horizontal to enable gravity to pull the printed part off the print bed upon completion of the print.

10. The method according to claim 7 comprising providing Peltier devices under the print bed to facilitate cooling of the print bed for release of the part from the printed bed.

11. The method according to claim 7 comprising conducting a sweep of the print bed upon completion of the print to dislodge the printed part.

12. The method according to claim 7 comprising vibrating the print bed upon completion of the print to dislodge the printed part.

13. The method according to claim 7 comprising using one or more of an ion gun, air blade, air compressor, and anti-static compound applied to the print surface to assist with dislodging the printed part upon completion of the print.

14. The method according to claim 7 wherein the 3D printer comprises a Mendel style printer.

15. Apparatus for facilitating automated removal of a printed part from a 3D printer, comprising:
a print surface applied to the print bed of the 3D printer to facilitate release of printed part from a print bed, wherein the print surface comprises a material which bonds to the deposited printing material when heated, and once cooled, loses its bond to the deposited printing material; and
one or more heating and/or cooling mechanisms to cycle the temperature of the print surface to change the properties of the print surface to enable adhesion of the part to the print bed during printing and release of the part from the print bed upon completion of the print.

16. Apparatus according to claim 15 comprising a support for orienting the print bed vertically or substantially vertically to enable gravity to pull the printed part away from the print bed upon completion of the print.

17. Apparatus according to claim 15 comprising a support for orienting the print bed at an incline to the horizontal to enable gravity to pull the printed part off the print bed upon completion of the print.

18. Apparatus according to claim 15 comprising a Peltier device installed under the print bed to facilitate cooling of the print bed for release of the part from the printed bed.

19. Apparatus according to claim 15 comprising a sweeper operable to move across the print bed upon completion of the print to dislodge the printed part.

20. Apparatus according to claim 15 comprising a vibration mechanism for vibrating the print bed upon completion of the print to dislodge the printed part.

21. Apparatus according to claim 15 comprising one or more of an ion gun, air blade, air compressor, and anti-static compound applied to the print surface to assist with dislodging the printed part upon completion of the print.

22. Apparatus according to claim 15 comprising a filament detection mechanism to track the use of printing material filament.

23. Apparatus according to claim 22 wherein the filament detection mechanism comprises a load cell incorporated with the filament mount.

24. A printer incorporating the print surface of claims 1.

25. A system for control and management of print jobs to a plurality of printers in accordance with claim 24.

26. The system according to claim 25 configured to perform one or more of the following functions: remote printer control, print job delegation, print job scheduling, print failure detection, quality checks, inventory management, automatic filament setting generation, and print packing.

27. The system according to claim 26 wherein data concerning printer status is aggregated from the plurality of printers and is used to inform the one or more functions executed by the system.

28. (canceled)

29. (canceled)
